(19) United States
(12) Patent Application Publication
(10) Pub. No.: US 2025/0010206 A1
(43) Pub. Date: Jan. 9, 2025

(54) INFORMATION PROCESSING SYSTEM, NON-TRANSITORY COMPUTER-READABLE STORAGE MEDIUM, AND INFORMATION PROCESSING METHOD

(71) Applicant: NINTENDO CO., LTD., Kyoto-shi (JP)

(72) Inventors: Masayuki KIMURA, Kyoto-shi (JP); Takahiro BANDO, Kyoto-shi (JP); Yoshito UEYAMA, Kyoto-shi (JP); Kenji TATSUTA, Kyoto-shi (JP); Yoshiteru FUKUDA, Kyoto-shi (JP)

(21) Appl. No.: 18/749,017

(22) Filed: Jun. 20, 2024

(30) Foreign Application Priority Data
Jul. 4, 2023 (JP) 2023-110176

(51) Int. Cl. A63F 13/795; A63F 13/34; A63F 13/497; A63F 13/5375; A63F 13/86

(52) U.S. Cl. CPC A63F 13/795; A63F 13/34; A63F 13/497; A63F 13/5375; A63F 13/86

(57) ABSTRACT

An information processing system includes a competition management system, a host terminal, a participant terminal, and a participant game device. The competition management system includes game competition generation means configured to generate information for holding a game competition, registration means configured to register participant information, pairing information generation means configured to generate pairing information indicating pairing of participants who play a communication game, and pairing information update means configured to update the pairing information based on report data. The competition management system generates a session for play of the communication game together by participants designated by the pairing information, in association with the designated participants.

This nonprovisional application claims priority on Japanese Patent Application No. 2023-110176 filed with the Japan Patent Office on Jul. 4, 2023, the entire contents of which are hereby incorporated by reference.

### FIELD

The present disclosure relates to an information processing system, an information processing program, and an information processing method.

### BACKGROUND AND SUMMARY

In connection with a communication game that can be played by a plurality of users, in some cases, a game company which operates the communication game has conventionally held a specific event. It has been known that, when a predetermined day comes, a match-up game event is held and a plurality of users can participate in the match-up game event.

Since communication over the Internet between/among users who play a game has recently been facilitated with development of social media, a user himself/herself may host a game competition. Rather than the game company which operates the game, the user who plays the game voluntarily solicits participants and holds a game competition. When the user voluntarily holds the game competition, the user who hosts the game competition should perform complicated tasks for participants, such as notification of competition rules, pairing of participants who play the game, and adjustment of a schedule.

The present disclosure can realize a scheme for lessening loads imposed by tasks at the time when a user who is not a game operator hosts a game competition, in an information processing system that provides a communication game that can be played by a plurality of users.

(Configuration 1) An information processing system according to one embodiment is an information processing system that assists proceeding of a game competition where a communication game is utilized. The information processing system includes a competition management system configured with at least one information processing apparatus, the competition management system managing the game competition, a host terminal operated by a host, the host terminal configured to communicate with the competition management system, a participant terminal operated by a participant in the game competition, and a participant game device operated by the participant in the game competition. The competition management system includes one or more first processors and one or more first memories storing instructions. The instructions, when executed, cause the one or more first processors to perform operations including generating information for holding the game competition based on competition setting information inputted to the host terminal, in response to a participation request for participation in the game competition accepted from the participant terminal, registering participant information of a participant who has made the participation request and the game competition in association with each other, generating from a plurality of registered participation requests, pairing information indicating pairing of participants who play the communication game together, generating a session for play of the communication game together by participants in pairing designated by the pairing information among participants who have made the participation request for participation in the game competition, in association with the participants in the designated pairing, and transmitting session information corresponding to the generated session to the participant game device of the participant associated with the session. The participant game device includes one or more second processors and one or more second memories storing instructions. The instructions, when executed, cause the one or more second processors to perform operations including communicating with the participant game device of at least one other participant who participates in a session corresponding to the session information, executing the communication game together with the at least one other participant who participates in the session, and transmitting log data of the communication game to the competition management system. The instructions, when executed, cause the one or more first processors to perform operations including outputting the log data to at least one of the host terminal and the participant terminal, storing report data inputted to the participant terminal, the report data indicating a result of the communication game played by the participant, and upon a predetermined condition for the report data being satisfied, updating the pairing information based on the report data, with the result of the communication game being regarded as being finalized. The generating a session in association with the participants in the designated pairing includes generating a session for play of the communication game together by the participants in the pairing designated by the updated pairing information, in association with the participants in the designated pairing.

According to Configuration 1, a scheme for lessening loads imposed by tasks at the time when a user who is not a game operator hosts a game competition, in an information processing system that provides a communication game that can be played by a plurality of users can be realized.

(Configuration 2) In Configuration 1, the one or more first processors, responsive to executing the instructions, may further perform transmitting generation information indicating generation of the session to the participant terminal corresponding to the session.

According to Configuration 2, the participant terminal can notify the participant of generation of the session.

(Configuration 3) In Configuration 1 or 2, the one or more second processors, responsive to executing the instructions, may further perform outputting session information on the session corresponding to the obtained session information. The communicating with the participant game device of another participant includes communicating, based on an input to the session information of the participant, with another game device that participates in the session corresponding to the session information.

According to Configuration 3, the participant game device can notify the participant of generation of the session.

(Configuration 4) In any one of Configurations 1 to 3, the executing the communication game played together with the another participant includes executing the communication game, match-up condition setting of which is set in advance based on the competition setting information.

According to Configuration 4, tasks for setting of rules relating to a game match by the participant can be omitted.

(Configuration 5) In any one of Configurations 1 to 4, the information processing system further includes a host game device that executes the communication game. The host game device includes one or more third processors and one or more third memories storing instructions. The instructions, when executed by the one or more third processors, cause the one or more third processors to perform communicating with the participant game device who participates in a session designated by the host.

According to Configuration 5, the game match can be watched on the host game device.

(Configuration 6) In any one of Configurations 1 to 5, the one or more second processors, responsive to executing the instructions, may further perform transmitting to the competition management system, replay data for reproduction of the communication game executed by communication game execution means. The one or more first processors, responsive to executing the instructions, may further perform storing the replay data. The one or more second processors, responsive to executing the instructions, may further perform operations including obtaining the replay data from the competition management system and reproducing the communication game based on the replay data.

According to Configuration 6, replay of the game match played in the past in the competition can be checked on the game device with the use of replay data.

(Configuration 7) In any one of Configurations 1 to 6, the storing report data indicating a result of the communication game played by the participant includes storing the report data obtained from a plurality of participants who participated in the session. The updating the pairing information based on the report data may include determining, when contents indicated by the report data obtained at least from a first participant match with contents indicated by the report data obtained from a second participant among the participants who participated in the session, the predetermined condition as having been satisfied and updating the pairing information.

According to Configuration 7, even when log data contrary to the participant's intention is generated due to an unexpected trouble such as loss of the Internet connection, a result of the game match can be determined with importance being placed on the participant's opinion.

(Configuration 8) In any one of Configurations 1 to 7, the one or more first processors, responsive to executing the instructions, may further perform giving a notification to the host terminal based on an operation onto the participant terminal.

According to Configuration 8, during proceeding of the game competition, the participant can readily obtain support from the host.

(Configuration 9) In any one of Configurations 1 to 8, the one or more first processors, responsive to executing the instructions, may further perform editing the pairing information based on an operation onto the host terminal.

According to Configuration 9, the host can modify contents of the pairing information based on the host's own determination.

(Configuration 10) In any one of Configurations 1 to 9, the updating the pairing information based on the report data may include updating a result of the communication game based on an operation onto the host terminal regardless of whether the predetermined condition has been satisfied.

According to Configuration 10, the result of the game match can be updated with the host's rights.

(Configuration 11) In any one of Configurations 1 to 10, the one or more first processors, responsive to executing the instructions, may further perform discarding the session for playing the communication game after the result of communication game is finalized.

According to Configuration 11, after the game match ends, the session can be discarded to reduce a capacity used by unnecessary data.

(Configuration 12) In any one of Configurations 1 to 11, the communicating with the participant game device of another participant may include establishing peer to peer (P2P) communication with another participant game device that participates in the session.

According to Configuration 12, communication between the game devices can be P2P communication.

(Configuration 13) In any one of Configurations 1 to 12, the participant terminal includes one or more fourth processors and one or more fourth memories storing instructions. The instructions, when executed by the one or more fourth processors, cause the one or more fourth processors to perform showing a guidance image showing an action to be taken by the participant in accordance with a status of proceeding of the game competition or cause the one or more second processors, responsive to executing the instructions, to perform showing a guidance image showing an action to be taken by the participant in accordance with a status of proceeding of the game competition.

According to Configuration 13, with the guidance image, the participant can be assisted and the game competition can smoothly proceed.

(Configuration 14) In any one of Configurations 1 to 13, the host terminal includes one or more fifth processors and one or more fifth memories storing instructions. The instructions, when executed by the one or more fifth processors, cause the one or more fifth processors to perform showing a competition progress image showing progress of the game competition based at least on the report data obtained from the competition management system.

According to Configuration 14, the host can visually check progress of the game competition.

(Configuration 15) In any one of Configurations 1 to 14, the competition setting information may include a participation condition for participation in the game competition, and the registering participant information of a participant and the game competition in association with each other may include determining whether to make registration based on the participation condition.

According to Configuration 15, a user who does not satisfy the participation condition for participation in the game competition can automatically be excluded.

(Configuration 16) In any one of Configurations 1 to 15, the competition setting information may include a defined number of participants, and the updating the pairing information based on the report data may include generating the pairing information when the participation request(s) as many as the defined number of participants is/are received.

According to Configuration 16, the pairing information can be generated at the timing when there are defined number of participants.

(Configuration 17) A non-transitory computer-readable storage medium with an executable information processing program according to one embodiment stored thereon, the information processing program being executed by one or more processors included in an information processing system that assists proceeding of a game competition in which a communication game is utilized, is provided. The information processing system includes a competition management system configured with at least one information processing apparatus, the competition management system managing the game competition, a host terminal operated by a host, the host terminal configured to communicate with the competition management system, a participant terminal operated by a participant in the game competition, the participant terminal configured to communicate with the competition management system, and a participant game device operated by the participant in the game competition. The information processing program causes the one or more processors to perform operations including generating information for holding the game competition based on competition setting information inputted to the host terminal, in response to a participation request for participation in the game competition accepted from the participant terminal, registering participant information of a participant who has made the participation request and the game competition in association with each other, generating from a plurality of registered participation requests, pairing information indicating pairing of participants who play the communication game together, generating a session for play of the communication game together by participants in pairing designated by the pairing information among participants who have made the participation request for participation in the game competition, in association with the participants in the designated pairing, transmitting session information corresponding to the generated session to the participant game device of the participant associated with the session, outputting log data indicating a result of the communication game received from the participant game device to at least one of the host terminal and the participant terminal, storing report data inputted to the participant terminal, the report data indicating a result of the communication game played by the participant, upon a predetermined condition for the report data being satisfied, updating the pairing information based on the report data, with the result of the communication game being regarded as being finalized, and generating a session for play of the communication game together by the participants in the pairing designated by the updated pairing information, in association with the participants in the designated pairing.

According to Configuration 17, a scheme for lessening loads imposed by tasks at the time when a user who is not a game operator hosts a game competition, in an information processing system that provides a communication game that can be played by a plurality of users can be realized.

(Configuration 18) An information processing method according to one embodiment is an information processing method to be performed by one or more processors included in an information processing system that assists proceeding of a game competition in which a communication game is utilized. The information processing system includes a competition management system configured with at least one information processing apparatus, the competition management system managing the game competition, a host terminal operated by a host who is a user of the communication game, the host terminal configured to communicate with the competition management system, a participant terminal operated by a participant in the game competition, the participant terminal configured to communicate with the competition management system, and a participant game device operated by the participant in the game competition. The information processing method includes generating information for holding the game competition based on competition setting information inputted to the host terminal, in response to a participation request for participation in the game competition accepted from the participant terminal, registering participant information of a participant who has made the participation request and the game competition in association with each other, generating from a plurality of registered participation requests, pairing information indicating pairing of participants who play the communication game together, generating a session for play of the communication game together by participants in pairing designated by the pairing information among participants who have made the participation request for participation in the game competition, in association with the participants in the designated pairing, transmitting session information corresponding to the generated session to the participant game device of the participant associated with the session, outputting log data indicating a result of the communication game received from the participant game device to at least one of the host terminal and the participant terminal, storing report data inputted to the participant terminal, the report data indicating a result of the communication game played by the participant, upon a predetermined condition for the report data being satisfied, updating the pairing information based on the report data, with the result of the communication game being regarded as being finalized, and generating a session for play of the communication game together by the participants in the pairing designated by the updated pairing information, in association with the participants in the designated pairing.

According to Configuration 18, a scheme for lessening loads imposed by tasks at the time when a user who is not a game operator hosts a game competition, in an information processing system that provides a communication game that can be played by a plurality of users can be realized.

(Configuration 19) An information processing system according to one embodiment is an information processing system that assists proceeding of a game competition where a communication game is utilized. The information processing system includes a competition management system configured with at least one game competition, a host terminal operated by a host, the host terminal configured to communicate with the competition management system, a participant terminal operated by a participant in the game competition, the participant terminal configured to communicate with the competition management system, and a participant game device operated by the participant in the game competition. The competition management system includes one or more first processors and one or more first memories storing instructions. The instructions, when executed, cause the one or more first processors to perform operations including generating information for holding the game competition based on competition setting information inputted to the host terminal, in response to a participation request for participation in the game competition accepted from the participant terminal, registering participant information of a participant who has made the participation request and the game competition in association with each other, generating from a plurality of registered participation requests, pairing information indicating pairing of participants who play the communication game together, generating a session for play of the communication game together by participants in pairing designated by the pairing information among participants who have made the participation request for participation in the game competition, in association with the participants in the designated pairing, and transmitting session information corresponding to the generated session to the participant game device of the participant associated with the session. The participant game device includes one or more second processors and one or more second memories storing instructions. The instructions, when executed, cause the one or more second processors to perform operations including communicating with the participant game device of at least one other participant who participates in a session corresponding to the session information, executing the communication game together with the at least one other participant who participates in the session, and transmitting log data of the communication game to the competition management system. The instructions, when executed, cause the one or more first processors to perform operations including outputting the log data to at least one of the host terminal and the participant terminal and finalizing a result of the communication game based on the log data and updating the pairing information based on the finalized result of the communication game. The generating a session in association with the participants in the designated pairing includes generating a session for play of the communication game together by the participants in the pairing designated by the updated pairing information, in association with the participants in the designated pairing.

According to Configuration 19, a scheme for lessening loads imposed by tasks at the time when a user who is not a game operator hosts a game competition, in an information processing system that provides a communication game that can be played by a plurality of users can be realized.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary information processing system according to a first embodiment.

FIG. 2 shows an exemplary illustrative non-limiting drawing illustrating an exemplary hardware configuration of a management server included in the information processing system according to the first embodiment.

FIG. 3 shows an exemplary illustrative non-limiting drawing illustrating an exemplary hardware configuration of a terminal included in the information processing system according to the first embodiment.

FIG. 4 shows an exemplary illustrative non-limiting drawing illustrating an exemplary hardware configuration of a game device included in the information processing system according to the first embodiment.

FIG. 5 shows an exemplary illustrative non-limiting drawing illustrating an exemplary first sequence diagram showing proceeding of a game competition.

FIG. 6 shows an exemplary illustrative non-limiting drawing illustrating an exemplary second sequence diagram showing proceeding of the game competition.

FIG. 7 shows an exemplary illustrative non-limiting drawing illustrating an exemplary third sequence diagram showing proceeding of the game competition.

FIG. 8 shows an exemplary illustrative non-limiting drawing illustrating an exemplary result of pairing information generation processing by the management server.

FIG. 9 shows an exemplary illustrative non-limiting drawing illustrating an exemplary table.

FIG. 10 shows an exemplary illustrative non-limiting drawing illustrating an exemplary result of pairing information update processing by the management server.

FIG. 11 shows an exemplary illustrative non-limiting drawing illustrating an exemplary flowchart showing a procedure in processing for transmitting a game competition generation instruction.

FIG. 12 shows an exemplary illustrative non-limiting drawing illustrating an exemplary flowchart showing a procedure in participation request processing.

FIG. 13 shows an exemplary illustrative non-limiting drawing illustrating an exemplary flowchart showing a procedure in main processing for proceeding of the game competition.

FIG. 14 shows an exemplary illustrative non-limiting drawing illustrating an exemplary flowchart showing a procedure in processing for proceeding with a game match in a participant game device.

FIG. 15 shows an exemplary illustrative non-limiting drawing illustrating an exemplary flowchart showing a procedure in processing for proceeding with a game match in a participant terminal.

FIG. 16 shows an exemplary illustrative non-limiting drawing illustrating an exemplary flowchart showing a procedure in processing for proceeding with a game match in the management server.

FIG. 17 shows an exemplary illustrative non-limiting drawing illustrating an exemplary flowchart showing a procedure in giving a notification of a call request, in a host terminal.

FIG. 18 shows an exemplary illustrative non-limiting drawing illustrating an exemplary flowchart showing a processing procedure relating to proceeding of the game match in a host game device.

FIG. 19 shows an exemplary illustrative non-limiting drawing illustrating an exemplary flowchart showing processing for reproducing replay data in the game device.

FIG. 20 shows an exemplary illustrative non-limiting drawing illustrating an exemplary flowchart showing processing for showing a competition progress image, in the host terminal.

FIG. 21 shows an exemplary illustrative non-limiting drawing illustrating an exemplary competition progress image.

FIG. 22 shows an exemplary illustrative non-limiting drawing illustrating an exemplary information processing system according to a second embodiment.

FIG. 23 shows an exemplary illustrative non-limiting drawing illustrating an exemplary second sequence diagram showing proceeding of the game competition in a third embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### First Embodiment

### A. Overview

An exemplary configuration of a system that executes an application that provides a communication game according to the present embodiment will initially be described.

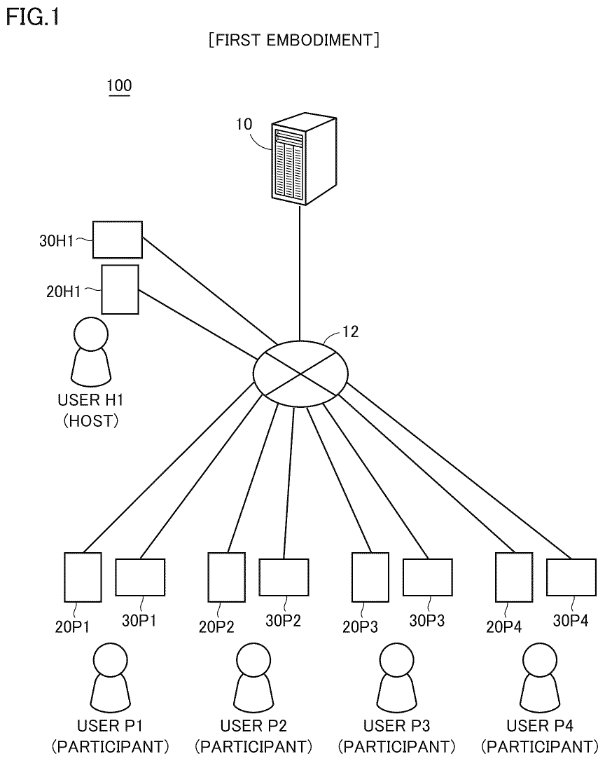

FIG. 1 is a schematic diagram showing an exemplary information processing system 100 according to a first embodiment. Information processing system 100 is a system that assists proceeding of a game competition in which a communication game is utilized. In the first embodiment, the game competition is a game competition where a specific communication game is used, and hosted by a user H1 who is a player of the communication game in the first embodiment. User H1 may correspond to the “host” in the present disclosure. In the first embodiment, user H1 is one of general players who play the communication game.

The “communication game” herein encompasses games with which one or more users are involved, and any type of game may be applicable. In the first embodiment, the communication game is a game of a player vs player (PvP) type in which users play against each other in a virtual space. A communication game played once or two or more times by users in specific pairing between which a winner and a loser should be decided in a game competition in a present example may be referred to as a “game match” below for the sake of convenience.

The game competition in the first embodiment proceeds by repeated execution of a game match between participants in the game competition. A form of proceeding of the game competition may be, for example, an elimination tournament, a league competition, or the like. In other words, the game competition includes a plurality of game matches and proceeds in accordance with a result of each game match.

User H1 informs the public that a game competition will be held, for example, over social media. Users P1 to P4 shown in FIG. 1 are informed through the social media that the game competition will be held and apply for participation in the game competition. Each of users P1 to P4 may correspond to the “participant” in the present disclosure. The participant does not have to be acquainted with the host for making an application for the game competition.

As shown in FIG. 1, information processing system 100 includes a management server 10, a host terminal 20H1, a host game device 30H1, participant terminals 20P1 to 20P4, and participant game devices 30P1 to 30P4. Management server 10 is composed of at least one information processing apparatus and comprehensively manages the game competition held by user H1. Specifically, management server 10 holds and updates data relating to proceeding of the game competition. Management server 10 in the first embodiment may correspond to the “competition management system” in the present disclosure.

Host terminal 20H1 is a communication terminal operated by the host. Participant terminals 20P1 to 20P4 are communication terminals operated by respective users P1 to P4. Each of host terminal 20H1 and participant terminals 20P1 to 20P4 is typically a smartphone, a personal computer, a tablet terminal, or the like. Participant terminals 20P1 to 20P4 will collectively be referred to as a “participant terminal 20P” below. Furthermore, host terminal 20H1 and participant terminal 20P will collectively be referred to as a “terminal 20”.

Host game device 30H1 is a game device operated by the host. Participant game devices 30P1 to 30P4 are game devices operated by respective users P1 to P4. Each of host game device 30H1 and participant game devices 30P1 to 30P4 may be an information processing apparatus dedicated for a game and capable of communication or a general-purpose personal computer. Participant game devices 30P1 to 30P4 will collectively be referred to as a “participant game device 30P” below. Furthermore, host game device 30H1 and participant game device 30P will collectively be referred to as a “game device 30.”

Host game device 30H1 may be identical to host terminal 20H1. In other words, host game device 30H1 may be configured as being integrated with host terminal 20H1, and host terminal 20H1 may execute the communication game. Similarly, participant game device 30P may be identical to participant terminal 20P. In other words, participant game device 30P may be configured as being integrated with participant terminal 20P, and participant terminal 20P may execute the communication game.

As shown in FIG. 1, communication among management server 10, game device 30, and terminal 20 is established over a network 12. Network 12 is typically the Internet.

### B. Exemplary Hardware Configuration

An exemplary hardware configuration of each of management server 10, game device 30, and terminal 20 included in information processing system 100 according to the present embodiment will now be described.

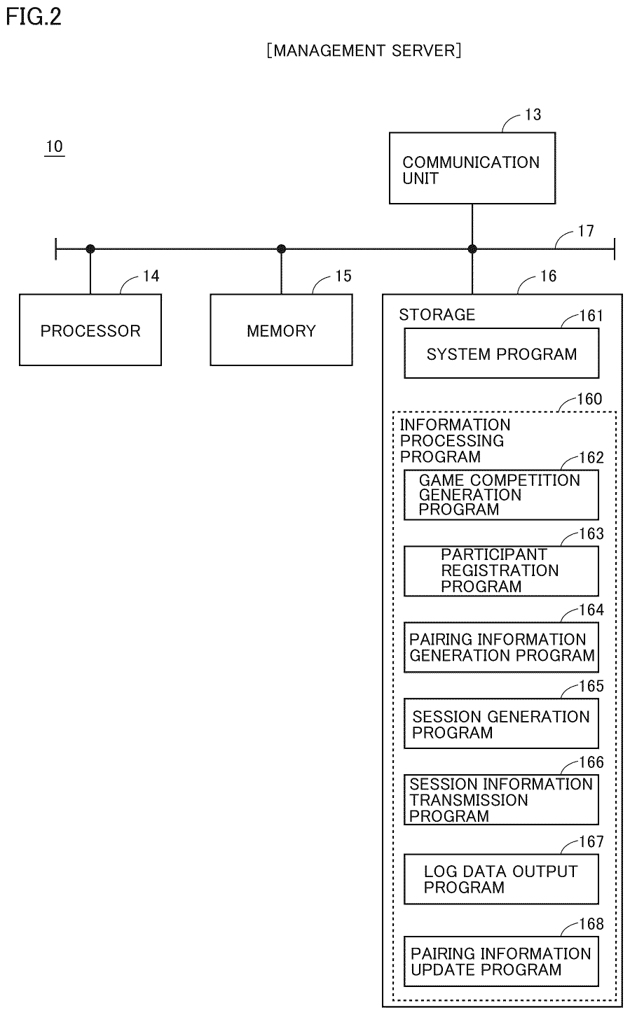

FIG. 2 is a schematic diagram of an exemplary hardware configuration of management server 10 included in information processing system 100 according to the first embodiment. Referring to FIG. 2, management server 10 includes one or more processors 14, a memory 15, a storage 16, and a communication unit 13. These components are connected to communicate data with one another through a bus 17. Management server 10 may be a dedicated information processing apparatus that manages a communication game or may be implemented by a general-purpose server.

Processor 14 is a processing entity for performing processing provided by management server 10. Processor 14 reads a system program 161 and an information processing program 160 stored in storage 16, and develops the same on memory 15 for execution. System program 161 is a program for operating management server 10 and includes, for example, an operating system (OS) and firmware.

Information processing program 160 includes a game competition generation program 162, a participant registration program 163, a pairing information generation program 164, a session generation program 165, a session information transmission program 166, a log data output program 167, and a pairing information update program 168.

Game competition generation program 162 is a program for generating data necessary for holding a game competition and securing a storage area. Participant registration program 163 is a program for registering a participant who makes an application for a game competition. Pairing information generation program 164 is a program for determining pairing of registered participants. Session generation program 165 is a program for generating a session for play of a communication game by participants.

The session refers to a virtual area in storage 16 or memory 15 for management of a plurality of participants who play the communication game. A plurality of participant game devices 30P operated by a plurality of participants who participate in the session are in a state where they can indirectly or directly communicate with one another through a server. The session can be regarded as a virtual room prepared in management server 30.

Session information transmission program 166 is a program for transmission of information on the generated session to each of participant game devices 30P1 to 30P4. Log data output program 167 is a program for output of log data indicating a result of the communication game to host terminal 20H1 and participant terminals 20P1 to 20P4. Pairing information update program 168 is a program for update of pairing of participants with proceeding of the game competition.

Memory 15 is a volatile storage device (storage medium) accessible by processor 14, and for example, a dynamic random access memory (DRAM) or a static random access memory (SRAM) may be employed.

Storage 16 is a non-volatile storage device (storage medium) accessible by processor 14, and for example, a hard disk or a flash memory may be employed. Storage 16 may be, for example, a storage medium attachable to and removable from management server 10, such as an optical disc and a cartridge.

System program 161 and information processing program 160 include an instruction code for implementing processing which will be described later. The “program” that implements processing according to the present embodiment encompasses an instruction code included in system program 161 and an instruction code of an application program included in information processing program 160.

Communication unit 13 communicates with terminal 20 or game device 30 over network 12. Communication unit 13 may include hardware necessary for wired communication and/or hardware necessary for wireless communication. The entirety or a part of processing by communication unit 13 may be performed by processor 14.

Processing performed in management server 10 may be implemented by execution of a program by processor 14, or a part or the entirety of the processing may be implemented by hard-wired circuitry such as an application specific integrated circuit (ASIC) or a field programmable gate array (FPGA).

The term “processor” herein encompasses also hard-wired circuitry such as an ASIC or an FPGA in addition to normal meaning of processing circuitry that performs processing in accordance with instruction codes described in a program, such as a central processing unit (CPU), a micro processing unit (MPU), or a graphics processing unit (GPU). In the hard-wired circuitry such as an ASIC or an FPGA, circuitry corresponding to processing to be executed is formed in advance. Furthermore, the “processor” herein also encompasses circuitry in which a plurality of functions are integrated, such as a system on chip (SoC).

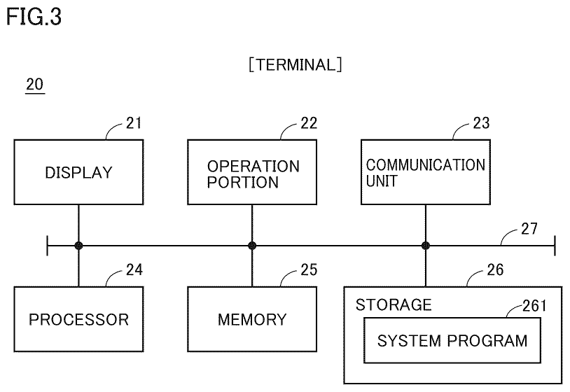

FIG. 3 is a schematic diagram showing an exemplary hardware configuration of terminal 20 (host terminal 20H1 and participant terminals 20P1 to 20P4) included in information processing system 100 according to the first embodiment. Since the configuration of a communication unit 23, a processor 24, a memory 25, and a storage 26 shown in FIG. 3 corresponds to the configuration of communication unit 13, processor 14, memory 15, and storage 16 described with reference to FIG. 2 and they are similar to each other, description will not be repeated.

Components included in terminal 20 are connected to communicate data with one another through a bus 27. A system program 261 in storage 26 is a program for operating terminal 20 and includes, for example, an OS and firmware. Terminal 20 further includes a display 21 and an operation portion 22.

Display 21 shows an image generated as a result of information processing performed in processor 24. Display 21 may be composed of a plurality of displays. Operation portion 22 accepts an operation by a user who operates terminal 20. Operation portion 22 includes, for example, a push button, a control lever, a touch panel, a mouse, a keyboard, and/or the like.

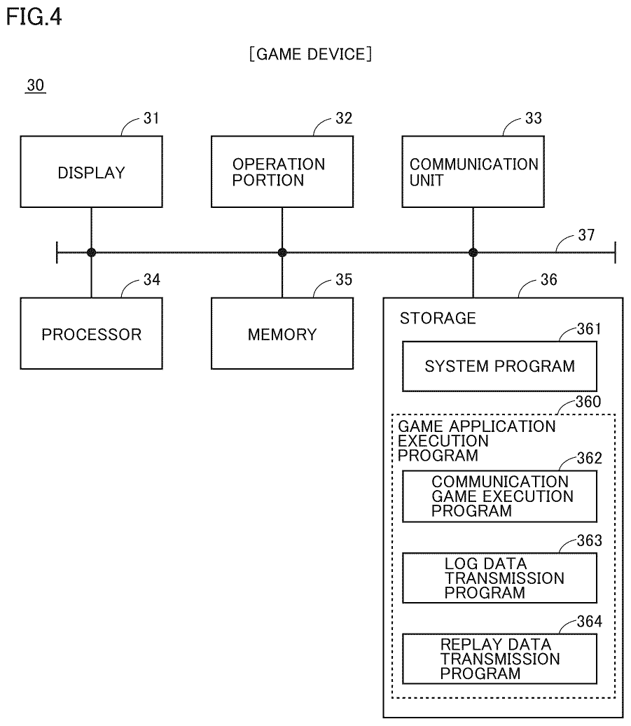

FIG. 4 is a schematic diagram showing an exemplary hardware configuration of game device 30 (host game device 30H1 and participant game devices 30P1 to 30P4) included in information processing system 100 according to the first embodiment.

Since the configuration of a communication unit 33, a processor 34, a memory 35, and a storage 36 shown in FIG. 4 corresponds to the configuration of communication unit 13, processor 14, memory 15, and storage 16 described with reference to FIG. 2 and they are similar to each other, description will not be repeated. In addition, since the configuration of a display 31 and an operation portion 32 shown in FIG. 4 corresponds to the configuration of display 21 and operation portion 22 described with reference to FIG. 3 and they are similar to each other, description will not be repeated.

Components included in game device 30 are connected to communicate data with one another through a bus 37. A system program 361 in storage 36 is a program for operating game device 30 and includes, for example, an OS and firmware.

A game application execution program 360 in addition to system program 361 is stored in storage 36. Game application execution program 360 includes a communication game execution program 362, a log data transmission program 363, and a replay data transmission program 364.

Communication game execution program 362 is a program for execution of a communication game in a game competition in the present example. Log data transmission program 363 is a program for transmission of log data indicating a result of the communication game in the game competition. Replay data transmission program 364 is a program for transmission of replay data for reproduction of contents in the communication game that ended in the game competition. Processing performed by communication game execution program 362 may correspond to “executing the communication game played together with the at least one other participant” in the present disclosure.

### C. Proceeding of Game Competition

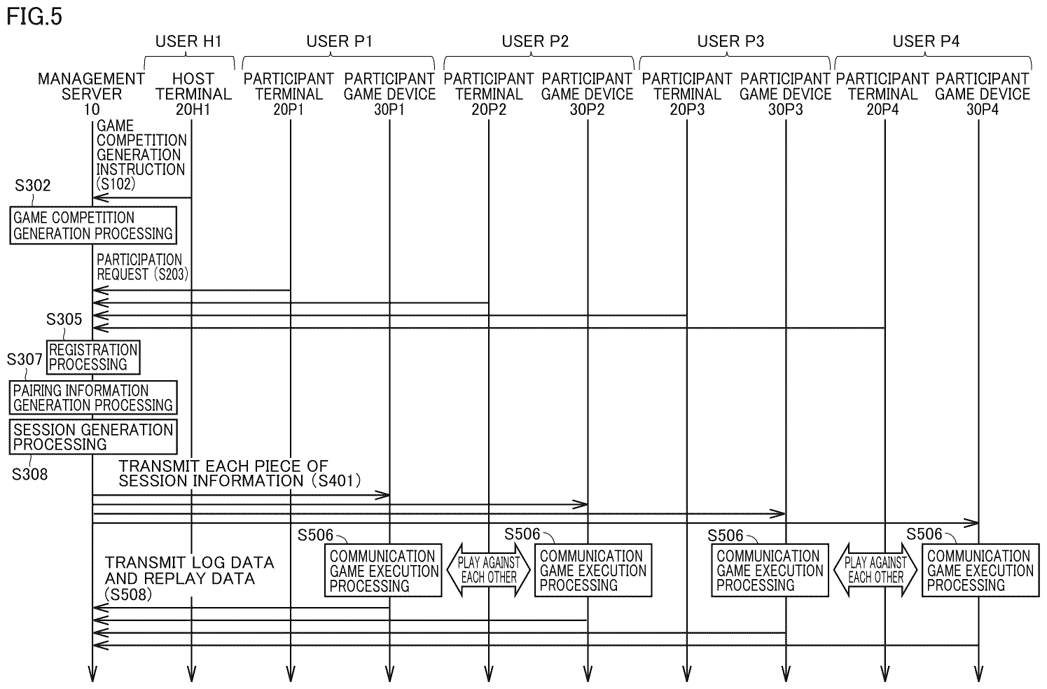

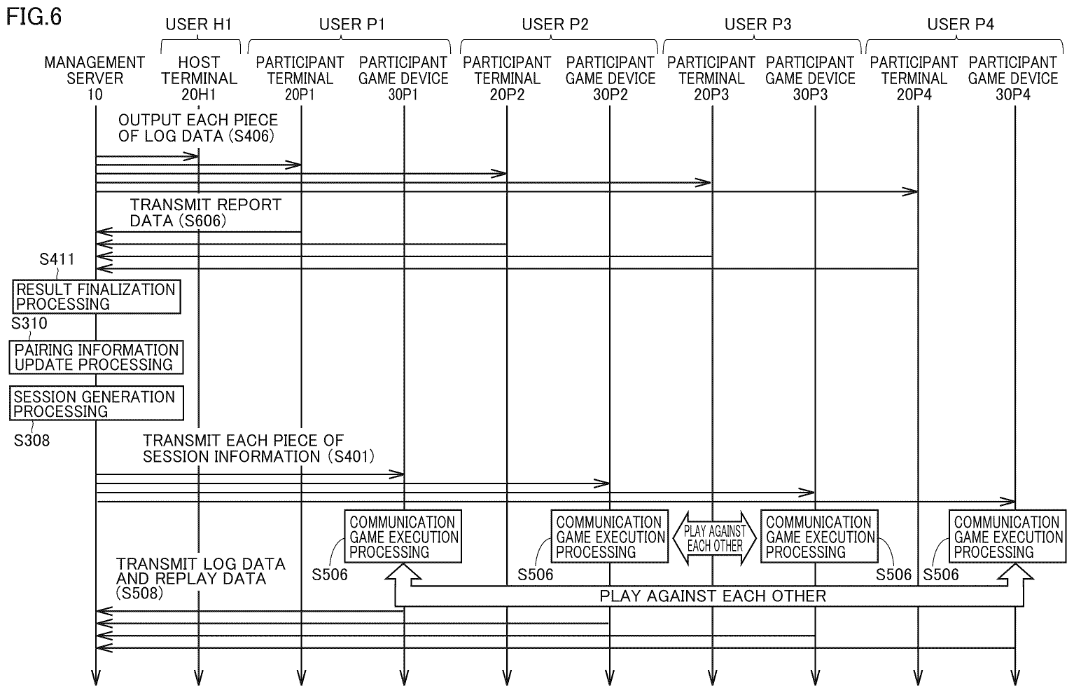

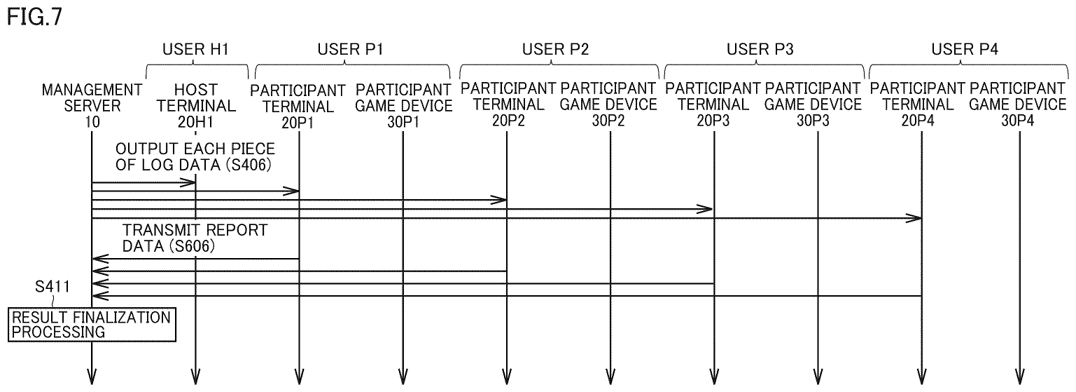

A flow of proceeding of a game competition will be described below with reference to FIGS. 5 to 7. FIG. 5 is a first sequence diagram showing proceeding of a game competition. FIG. 6 is a second sequence diagram showing proceeding of the game competition. FIG. 7 is a third sequence diagram showing proceeding of the game competition. FIG. 6 shows processing subsequent to FIG. 5 and FIG. 7 shows processing subsequent to FIG. 6.

In an upper portion in each of FIGS. 5 to 7, management server 10, host terminal 20H1 operated by user H1 (host), participant terminal 20P1 and participant game device 30P1 operated by user P1 (participant), participant terminal 20P2 and participant game device 30P2 operated by user P2 (participant), participant terminal 20P3 and participant game device 30P3 operated by user P3 (participant), and participant terminal 20P4 and participant game device 30P4 operated by user P4 (participant) are shown.

In the first embodiment, user H1 provides to host terminal 20H1, competition setting information which is information necessary for generation of the game competition. The competition setting information may include, for example, a name of the game competition, a form of proceeding of the game competition, a defined number of participants which defines the maximum number of persons who can participate in the game competition, a participation condition for participation in the game competition, rules in a game match played in the game competition, time and date when the game competition is held, and a period during which application from participants are accepted. In the example in the first embodiment, user H1 (host) inputs an “elimination tournament” as the form of proceeding of the game competition and inputs “four” as the defined number of participants. Rules for the game match may include, for example, a condition for victory in the game match, the number of participants in the game match, a character to be used by the participant, and restriction on a weapon associated with the character. The rules for the game match may correspond to the “match-up condition setting” in the present disclosure.

Host terminal 20H1 transmits a game competition generation instruction including the competition setting information to management server 10 based on input of the competition setting information from user H1 (step S102). Management server 10 performs game competition generation processing based on reception of the game competition generation instruction from host terminal 20H1 (S302). Processor 14 of management server 10 performs the game competition generation processing by executing game competition generation program 162. In the game competition generation processing, a storage area is secured in storage 16 for holding the game competition based on the received competition setting information, and a uniform resource locator (URL) for the participant is generated. The URL for the participant is a URL for an application for participation by a user who desires to participate in the game competition.

Management server 10 performs the game competition generation processing and thereafter transmits the URL for the participant to host terminal 20H1. User H1 (host) informs users of the communication game who may participate of the received URL for the participant. As described above, in the first embodiment, user H1 (host) informs the users of the URL for the participant through social media. Alternatively, user H1 (host) may transmit via a mail or the like, the URL for the participant directly to the users of the communication game acquainted therewith.

In the example in the first embodiment, users P1 to P4 apply for the game competition. Users P1 to P4 use respective participant terminals 20P1 to 20P4 to access the URL for the participant and input participant information to thereby complete application processing.

The participant information includes, for example, a user name of the participant, information for identification of game device 30 which the participant uses, an indicator indicating skills in the communication game, a total time period of play of the communication game, a history of participation in competitions in the past, past records, and other game account information. Each of participant terminals 20P1 to 20P4 transmits a participation request including the participant information to management server 10 based on input of the participant information (step S203).

Management server 10 performs registration processing based on reception of the participation request from participant terminal 20P (step S305). Processor 14 of management server 10 performs the registration processing by executing participant registration program 163. The registration processing is processing for determining whether or not the participant information included in the participation request satisfies the participation condition set by the host and storing the participant information in storage 16 in association with the game competition when the user who has made the application satisfies the participation condition. When the participant information included in the participation request does not satisfy the participation condition, management server 10 transmits to participant terminal 20P, a message that the participation condition is not satisfied.

Management server 10 performs the registration processing for each participation request. Specifically, in the example in FIG. 5, management server 10 performs the registration processing four times. Since all of users P1 to P4 satisfy the participation condition set by the host in the example in FIG. 5, management server 10 has the participant information of users P1 to P4 stored in storage 16 as the participants in the game competition. Management server 10 performs pairing information generation processing based on the fact that the number of registered participants has reached the defined number of participants (step S307). Management server 10 may perform the pairing information generation processing based on the fact that defined time has come, regardless of whether or not the number of registered participants has reached the defined number of participants.

Processor 14 of management server 10 performs the pairing information generation processing by executing pairing information generation program 164. The pairing information generation processing is processing for determining pairing of participants who play a game match together. The pairing information is information indicating which participants among a plurality of participants play together in which game match among a plurality of game matches included in the game competition. The pairing information may be, for example, a tournament chart, a list of matches in a league competition, or the like.

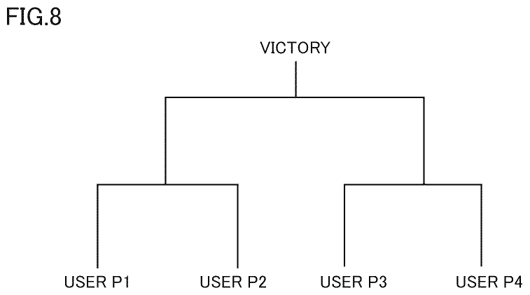

In the first embodiment, user H1 (host) sets the elimination tournament as the form of proceeding of the game competition. FIG. 8 is a diagram showing an exemplary result of the pairing information generation processing by management server 10. In the first embodiment, management server 10 generates the tournament chart including users P1 to P4 as the participants, by executing pairing information generation program 164.

As shown in FIG. 8, user P1 and user P2 play the game match together. In the present example, “playing the game match together” means that, while a game terminal of user P1 and a game terminal of user P2 communicate to synchronize a status of proceeding of the communication game with each other, user P1 and user P2 play together the communication game executed on their respective terminals. In other words, user P1 and user P2 play against each other. In addition, user P3 and user P4 play the game match together. In other words, user P3 and user P4 play against each other. Though an example in which two participants play against each other in a single game match is described in the first embodiment, in one aspect, three or more participants may participate in a single game match and play against one another. When three or more participants participate, the participants may be in opponent relation against one another.

The pairing information is thus information indicating which participants among a plurality of participants play together for each game match. In other words, the tournament chart plays a role to designate participants (opponents) between/among which the game match is played. The tournament chart in FIG. 8 may correspond to the “pairing information” in the present disclosure. In the first embodiment, management server 10 randomly generates pairing of participants to play against each other, with the use of random numbers.

Furthermore, in the first embodiment, the host can edit the pairing information determined by management server 10. Specifically, the host transmits an edition instruction to edit the pairing information to management server 10 by operating host terminal 20H1. Management server 10 edits the pairing information based on reception of the edition instruction. For example, management server 10 edits the tournament chart in FIG. 8 such that user P1 and user P3 play against each other and user P2 and user P4 play against each other.

Referring back to FIG. 5, management server 10 performs session generation processing based on the fact that set time and date when the game competition is to be held comes (step S308). Processor 14 of management server 10 performs the session generation processing by executing session generation program 165. The session generation processing is processing for generating a virtual area (session) on the server that manages players who play the game match together.

The competition setting information set by the host is stored in the generated session in association. For example, the rules for the game match are stored in the session in storage 16 of management server 10 in association. In addition, the time and date of start of the game match is also associated with the generated session for each game match.

The session is generated for each game match. In the first embodiment, after management server 10 generates the tournament chart in FIG. 8, it generates two sessions. The participant accesses the virtual area on the server from participant game device 30P of the participant himself/herself. Access to the virtual area by the participant will be referred to as “participation in the session” below.

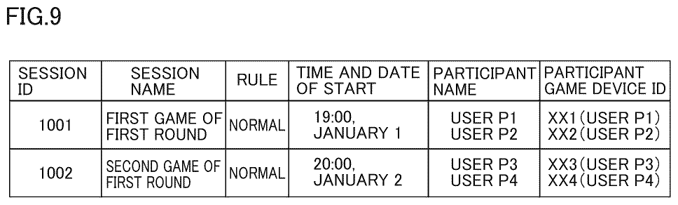

Management server 10 transmits session information for access to the generated session to participant game device 30P. The session information is, for example, an ID for identification of the session in which the participant is to participate among a plurality of sessions. FIG. 9 is a diagram showing a table of sessions managed by management server 10. As shown in FIG. 9, a session is generated for each game match and managed by management server 10.

Referring back to FIG. 6, management server 10 transmits the session information (session ID) corresponding to the session in which the participant is to participate to participant game device 30P by referring to the information (participant game device ID) that identifies participant game device 30P in the participant information (S401). Processor 14 of management server 10 performs session information transmission processing by executing session information transmission program 166.

Specifically, management server 10 transmits the session information for play by user P1 and user P2 against each other to participant game device 30P1 and participant game device 30P2. In addition, management server 10 transmits the session information for play by user P3 and user P4 against each other to participant game device 30P3 and participant game device 30P4.

The participants who participate in the session execute the communication game between participant game devices 30 (S506). As shown in FIG. 5, user P1 and user P2 execute the communication game which they play together. In addition, user P3 and user P4 execute the communication game which they play together. Time when user P1 and user P2 play the communication game may be different from time when user P3 and user P4 play the communication game. In other words, management server 10 may determine time and date to start the communication game for each communication game.

Processor 34 of game device 30 performs communication game execution processing by executing communication game execution program 362. In the first embodiment, communication units 33 of participant game devices 30P exchange processing of the communication game itself between participant game devices 30P by peer to peer (P2P) communication. Processing of the communication game itself is thus smoothly performed.

Participant game device 30P transmits log data and replay data to management server 10 based on end of the game match (S508). Processor 34 of participant game device 30P performs log data transmission processing by executing log data transmission program 363. In addition, processor 34 of participant game device 30P performs replay data transmission processing by executing replay data transmission program 364.

The log data is data indicating a result of the communication game. More specifically, the log data is information that identifies the participant who won the match and the participant who lost the match between the plurality of participants who executed the communication game. The replay data is data for reproduction of the communication game that ended. More specifically, the replay data includes a type of a command inputted by the participant in participant game device 30P during the communication game and information on timing of input of the command.

Game device 30 can reproduce the communication game that ended, based on information on at which timing each participant inputted which command during the communication game. Management server 10 has the received log data and replay data stored in storage 16 in association with the session corresponding to the log data and the replay data. Storage 16 may correspond to “storing replay data” in the present disclosure.

In succession, referring to FIG. 6, management server 10 notifies terminals 20 of the host and the participant of a result of each game match (S406). Specifically, management server 10 outputs log data received from participant game devices 30P1 to 30P4 to participant terminals 20P1 to 20P4, respectively. In addition, management server 10 transmits all of log data received from participant game device 30P to host terminal 20H1. Processor 14 of management server 10 performs log data output processing by executing log data output program 167.

In information processing system 100 in the first embodiment, after management server 10 outputs the log data, participant terminals 20P1 to 20P4 transmit report data to management server 10 (step S606). The report data refers to data indicating the result of the game match recognized by the participant himself/herself. The participant manually inputs the result of the game match by operating participant terminal 20P. Management server 10 has the received report data stored in storage 16. Storage 16 may correspond to “storing report data indicating a result of the communication game played by the participant” in the present disclosure.

In a communication game played over the Internet by a plurality of participants who are unacquainted with each other, an unexpected trouble may occur. The trouble may be, for example, loss of the Internet connection. The communication game may end against the participant's intention due to occurrence of the trouble. In such a case, game device 30 may determine that any participant won the game in spite of the fact that the communication game did not actually normally end, and may generate log data.

Since the game competition hosted in the first embodiment as described above is a competition hosted by user H1 who is the player of the communication game, unique rules determined by the host that cannot be set on the communication game may be adopted. The unique rules may include, for example, a rule that a participant the Internet connection of which was lost loses the communication game regardless of the result of the communication game when the Internet connection was successively lost. Game device 30 may determine that the participant the Internet connection of which was successively lost won the communication game depending on contents therein. By applying the unique rules determined by the host, however, the winner determined by game device 30 may be different from the winner recognized by the participant.

In other words, the winner indicated by the log data of the communication game may be different from the winner based on reflection of the unique rules. Thus, in the communication game played by a plurality of participants over the Internet, there may be discrepancy in recognition of the result of the game match between the participants after the end of the game match.

In information processing system 100 in the first embodiment, all participants are obliged to submit the report data after the end of the game match. In the example in the first embodiment, management server 10 performs result finalization processing for finalizing the result of the game match upon a predetermined condition for the report data being satisfied (step S411). The predetermined condition for the report data is matching of contents in the report data received from a plurality of participants.

More specifically, matching of the contents in the report data is, for example, submission of the report data indicating victory of user P2 from each of user P1 and user P2 after the game match in which user P1 and user P2 play against each other ends. Information processing system 100 can thus suppress proceeding of the game competition while there is discrepancy between the results of the game match recognized by the plurality of participants. In other words, proceeding of the game competition in spite of the fact that the participants do not agree with the results of the game match can be suppressed. In the example described above, user P1 may correspond to the “first participant” in the present disclosure. User P2 may correspond to the “second participant” in the present disclosure.

When the contents in the report data do not match, management server 10 requests users P1 and P2 to submit again the report data. When the contents in the report data do not match even after re-submission of the report data, management server 10 notifies host terminal 20H1 that the contents in the report data do not match.

In the example in FIG. 6, the contents in the report data match in all game matches. Management server 10 finalizes the result of the game match that user P2 defeated user P1 and the result of the game match that user P3 defeated user P4. In succession, management server 10 performs processing for updating pairing information (step S310). Processor 14 of management server 10 performs pairing information update processing by executing pairing information update program 168. Specifically, management server 10 updates the tournament chart based on the result of the game match finalized in step S411.

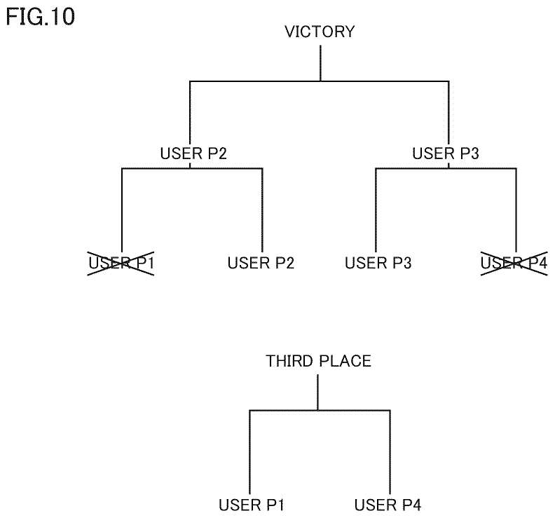

FIG. 10 is a diagram showing an exemplary result of pairing information update processing by management server 10. As shown in FIG. 10, management server 10 updates the tournament chart such that a game match (a final) in which user P2 who defeated user P1 plays against user P3 who defeated user P4 is held. In addition, management server 10 updates the tournament chart such that a game match (a third place match) in which user P1 defeated by user P2 plays against user P4 defeated by user P3 is held. Thus, in the first embodiment, pairing for determining ranks (first to fourth places) of the participants in the game competition can automatically be generated.

Referring back to FIG. 6, management server 10 again performs the session generation processing (step S308) and transmits the session information on the generated session. Specifically, management server 10 transmits the session information for play by user P2 and user P3 against each other to participant game device 30P2 and participant game device 30P3. In addition, management server 10 transmits the session information for play by user P1 and user P4 against each other to participant game device 30P1 and participant game device 30P4.

The participant who has received the session information executes the communication game again (S506). As shown in FIG. 6, user P2 and user P3 play against each other. After the communication game ends, participant game devices 30P2 and 30P3 transmit the log data and the replay data (step S508). In addition, as shown in FIG. 6, user P1 and user P4 play against each other. After the communication game ends, each of participant game devices 30P1 and 30P4 transmits the log data and the replay data (step S508).

Referring to FIG. 7, management server 10 transmits to terminal 20, the log data indicating the result of the communication game by user P1 and user P4 and the log data indicating the result of the communication game by user P2 and user P3. Thereafter, user P2 and user P3 submit the result of the game match (final) recognized by each of them as the report data to management server 10. User P1 and user P4 submit the result of the game match (third place match) recognized by each of them as the report data to management server 10. In other words, as shown in FIG. 7, each of participant terminals 20P transmits the report data (step S606).

Management server 10 finalizes the results of all game matches based on the report data (S411) and terminates the game competition. Thus, in information processing system 100 in the first embodiment, since management server 10 automatically generates and updates the tournament chart and automatically transmits the session information to each participant, loads imposed by tasks on user H1 (host) who hosts the game competition can be lessened.

The first embodiment illustrates the example where the game match is executed four times in the game competition in the form of the elimination tournament where the defined number of participants is set to four. When the defined number of participants is larger than four or when the form of proceeding of the game competition is the league competition, the number of times of the game match held in the game competition may be larger than four. In this case as well, by repeatedly updating the pairing information after the game match is finalized, management server 10 can proceed with the game competition while loads imposed by tasks on user H1 (host) are lessened.

### D. Processing Procedure

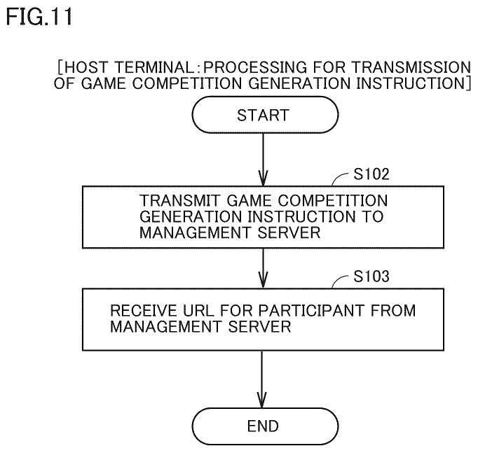

Processing by each apparatus included in information processing system 100 will be described below with reference to flowcharts in FIGS. 11 to 20. Steps described with reference to FIGS. 4 to 6 correspond to steps in the flowcharts shown in FIGS. 11 to 20.

### <D1. Preparation Period for Holding Game Competition>

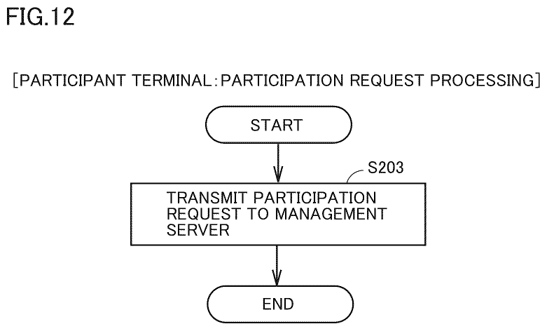

Preparation processing for holding a game competition will initially be described with reference to FIGS. 11 and 12. FIG. 11 is a flowchart showing a procedure in processing for transmitting a game competition generation instruction. The flowchart shown in FIG. 11 is performed by execution of system program 261 by processor 24 of host terminal 20H1.

Host terminal 20H1 performs the flowchart shown in FIG. 11 when it accepts an instruction for generation of a game competition from the host. Host terminal 20H1 transmits a game competition generation instruction including the competition setting information inputted by the host to management server 10 (step S102).

Thereafter, host terminal 20H1 receives a URL for the participant from management server 10 (step S103). The host shares the URL for the participant with a desired user, participation of which is desired by the host, by using social media or a message transmission and reception application.

FIG. 12 is a flowchart showing a procedure in participation request processing. The flowchart shown in FIG. 11 is performed by execution of system program 261 by processor 24 of participant terminal 20P. Participant terminal 20P starts the participation request processing by accessing the URL for the participant shared with the host.

Participant terminal 20P transmits a participation request for participation in the game competition to management server 10 based on the participant information inputted by the participant (step S203). In other words, the participation request includes participant information.

### <D2. Main Processing in Proceeding of Game Competition>

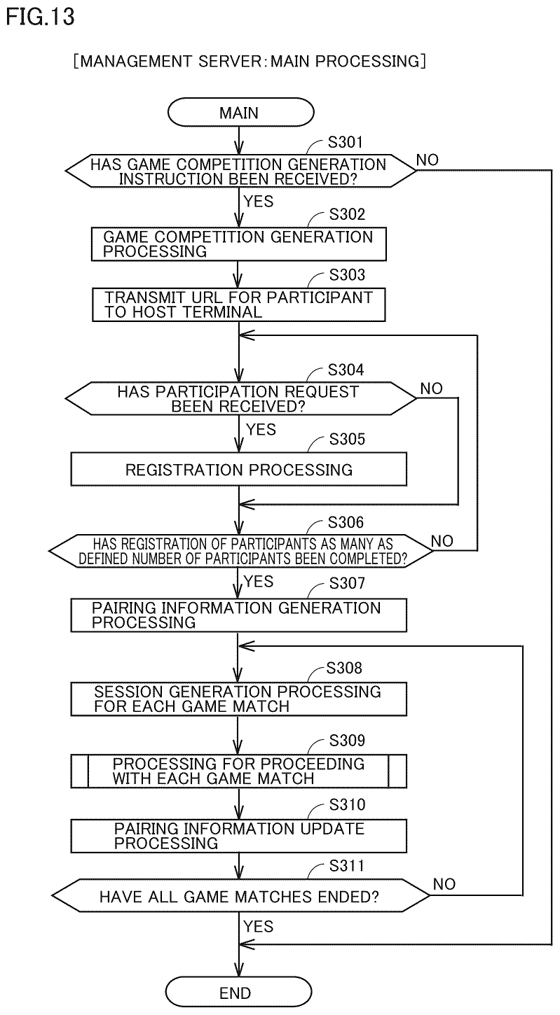

In succession, main processing in proceeding of the game competition by management server 10 will be described with reference to FIG. 13. FIG. 13 is a flowchart showing a procedure in the main processing of proceeding of the game competition. The flowchart shown in FIG. 13 is performed by execution of system program 161 and information processing program 160 by processor 14 of management server 10.

Management server 10 determines whether or not it has received the game competition generation instruction from host terminal 20H1 (step S301). When management server 10 has not received the game competition generation instruction (NO in step S301), it quits the process. When management server 10 has received the game competition generation instruction (YES in step S301), it performs the game competition generation processing (step S302). Specifically, management server 10 secures a storage area required for holding the game competition and generates data such as the URL for the participant based on the competition setting information included in the game competition generation instruction.

Management server 10 transmits the URL for the participant to host terminal 20H1 (step S303). Thereafter, management server 10 determines whether or not it has received the participation request (step S304). When management server 10 has received the participation request (YES in step S304), it performs the registration processing for registering the participant (step S305).

Management server 10 determines whether or not it has received the participation requests as many as the defined number of participants (step S306). When management server 10 has not received the participation requests as many as the defined number of participants (NO in step S306), it has the process return to step S304. When management server 10 has not received the participation request in step S304 (NO in step S304), it performs processing in step S306.

Management server 10 thus stands by until it receives the participation requests as many as the defined number of participants. When a state that management server 10 has not received the participation requests as many as the defined number of participants continues for a predetermined period, management server 10 may notify host terminal 20H1 and participant terminal 20P that participants as many as the defined number of participants were not attracted and quit the process.

When management server 10 has received the participation requests as many as the defined number of participants (YES in step S306), it performs the pairing information generation processing (step S307). Specifically, management server 10 determines pairing in the game match to be played by each participant at the timing of reception of the participation requests as many as the defined number of participants.

After management server 10 performs the pairing information generation processing, it performs the session generation processing for each game match (step S308). Management server 10 performs game match proceeding processing for each game match (step S309). Management server 10 generates the session in conformity with start time determined for each game match.

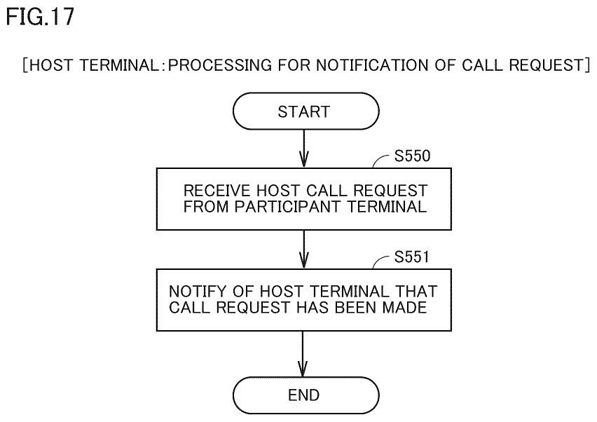

Contents in the game match proceeding processing will be described with reference to FIG. 17. After the game match proceeding processing ends, management server 10 performs the pairing information update processing (step S310). Management server 10 determines whether or not all game matches included in the game competition have ended (step S311).

When all game matches have not ended (NO in step S311), management server 10 has the process return to step S308. Specifically, management server 10 repeats the session generation processing, the game match proceeding processing, and the pairing information update processing until all game matches end. When all game matches have ended (YES in step S311), management server 10 quits the main processing and terminates the game competition.

### <D3. During Proceeding of Game Match>

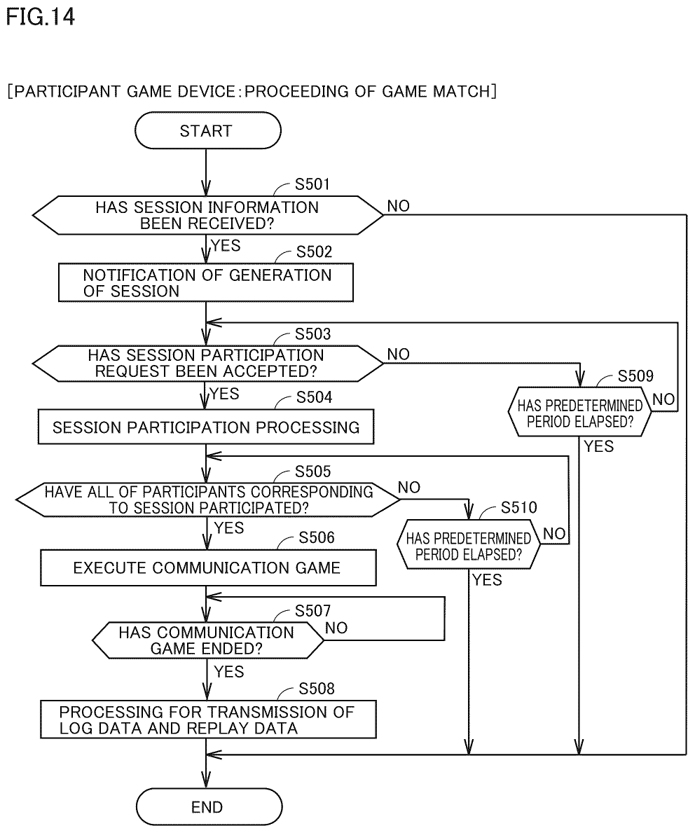

In succession, processing relating to proceeding of the game match will be described with reference to FIGS. 14 to 16. FIG. 14 is a flowchart showing a procedure in processing for proceeding with the game match in participant game device 30P. The flowchart shown in FIG. 14 is performed by execution of system program 361 and game application execution program 360 by processor 34 of participant game device 30P. Processing shown in FIG. 14 is processing performed after the participation request is transmitted.

Participant game device 30P determines whether or not it has received the session information from management server 10 (step S501). When participant game device 30P has not received the session information (NO in step S501), it quits the process. When participant game device 30P has received the session information (YES in step S501), it notifies that the session has been generated (step S502).

For example, participant game device 30P shows on display 31 that the participant who owns participant game device 30P should participate in the session because the session in which the participant should participate has been generated. The participant can thus recognize a state that the participant can execute the communication game by participating in the session. In other words, in the first embodiment, the participant is encouraged to participate in the session by being notified of generation of the session in the communication game in which a plurality of participants simultaneously play. Thus, in the first embodiment, undue waiting by the other participant while one participant has not participated in the session in spite of generation of the session can be suppressed.

Participant game device 30P determines whether or not it has accepted a session participation request from the participant (step S503). The participant makes the session participation request through operation portion 32 of participant game device 30P. When participant game device 30P has not accepted the session participation request (NO in step S503), it determines whether or not a predetermined period has elapsed since notification of generation of the session (step S509).

When the predetermined period in step S509 has not elapsed (NO in step S509), participant game device 30P has the process return to step S503. When the predetermined period in step S509 has elapsed (YES in step S509), participant game device 30P transmits to management server 10, information indicating that the communication game was not played because the participant himself/herself who operates participant game device 30P did not participate in the session and quits the process.

When participant game device 30P has accepted the session participation request from the participant (YES in step S503), it performs session participation processing (step S504). The participant can play the game match against another participant who has participated in the same session, by participating in the session. Participant game device 30P reads the rules of the game match stored in association with the session.

Specifically, participant game device 30P determines the rules in execution of the communication game, based on the competition setting information set by the host. Participant game device 30P can thus read the rules of the communication game in conformity with regulations of the game competition simply by participating in the session, without setting by the participant himself/herself of the rules of the communication game set in advance by the host.

Participant game device 30P determines whether or not all of the participants corresponding to the session have participated (step S505). Specifically, participant game device 30P determines whether or not all of the participants who are to participate in the game match determined by the host have participated in the session. When all of the participants corresponding to the session have not participated (NO in step S505), participant game device 30P determines whether or not the predetermined period has elapsed since notification of generation of the session (step S510).

When the predetermined period in step S510 has not elapsed (NO in step S510), participant game device 30P has the process return to step S505. When the predetermined period in step S510 has elapsed (YES in step S510), participant game device 30P transmits to management server 10, information indicating that the game match was not played because other participants did not participate in the session and quits the process.

When all of the participants corresponding to the session have participated (YES in step S505), participant game device 30P executes the communication game (step S506). The communication game is executed based on the rules of the communication game determined in advance by the host. Participant game device 30P determines whether or not the communication game has ended (step S507). When the communication game has not ended (NO in step S507), participant game device 30P repeats processing in step S507.

When the communication game has ended (YES in step S507), participant game device 30P transmits to management server 10, the log data indicating the result of the communication game executed in step S507 and the replay data including information on a command inputted by the participant in the communication game executed in step S507 (step S508) and quits the process.

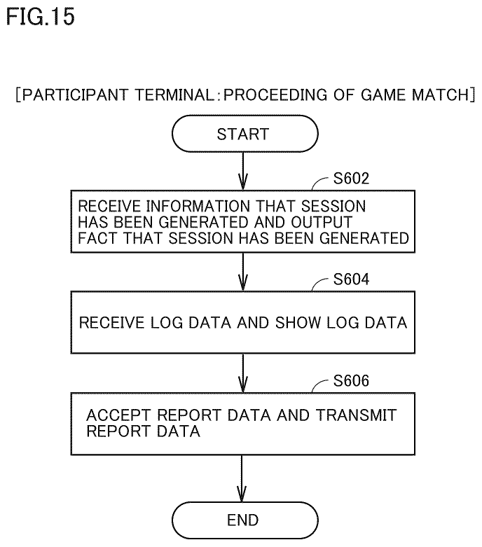

FIG. 15 is a flowchart showing a procedure in processing for proceeding with the game match in participant terminal 20P. The flowchart shown in FIG. 15 is performed by execution of system program 261 by processor 24 of participant terminal 20P. Processing shown in FIG. 15 is processing performed after transmission of the participation request.

Participant terminal 20P receives information indicating generation of the session from management server 10 and outputs the fact that the session has been generated (step S602). Processing for outputting the fact that the session has been generated may correspond to “communicating with the participant game device of another participant” in the present disclosure.

For example, participant terminal 20P shows on display 21 that the participant who owns participant terminal 20P should participate in the session because the session in which the participant should participate has been generated. More specifically, when participant terminal 20P is a portable terminal such as a smartphone, participant terminal 20P may notify the participant of generation of the session by a push notification or the like.

Thus, in the first embodiment, not only participant game device 30P but also participant terminal 20P can notify the participant of generation of the session to encourage the participant to participate in the session. Even when the participant has forgotten about the game competition itself and power of participant game device 30P is OFF, participant terminal 20P can have the participant recognize that the participant should participate in the session in the first embodiment.

In succession, participant terminal 20P receives the log data and shows on display 21, contents indicated by the received log data (step S604).

Furthermore, participant terminal 20P accepts the report data from the participant who finished the game match and transmits the report data to management server 10 (step S606), and quits the process. Participant terminal 20P shows on display 21, a guidance image for creation of the report data for a period from representation of the log data until acceptance of the report data.

The guidance image for creation of the report data is an image that suggests the participant to create the report data. For example, display 21 shows text that “which of users P1 and P2 is the winner of the game match?” as the guidance image. In addition, the guidance image may include a method of submitting more specific report data. For example, information on the game match necessary for creation of the report data may be included. In other words, the guidance image shows an action to be taken by the participant.

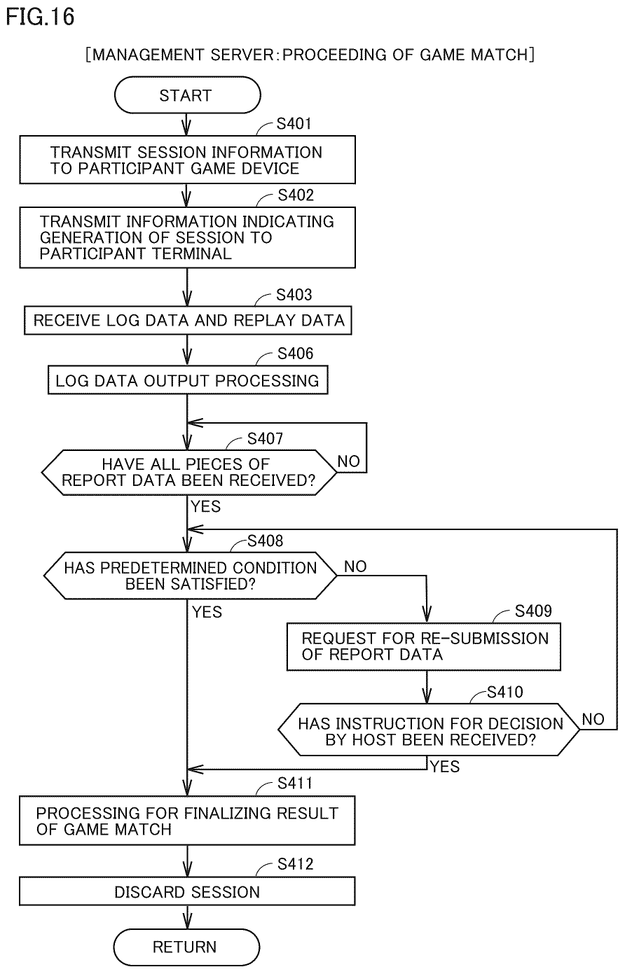

In succession, processing in management server 10 in connection with proceeding of the game match will be described. FIG. 16 is a flowchart showing a procedure in processing for proceeding with the game match in management server 10. The flowchart shown in FIG. 16 is performed by execution of system program 161 and information processing program 160 by processor 14 of management server 10. Management server 10 performs in step S309 in FIG. 13, the flowchart shown in FIG. 16.

Management server 10 transmits the session information to participant game device 30P of the participant who should participate in the session, based on the participant information associated with the session (step S401). Management server 10 transmits the session information before time and date of start of the game match set for each session. For example, management server 10 transmits the session information one hour before the time of start of the game match. Furthermore, management server 10 transmits generation information indicating generation of the session to participant terminal 20P (step S402).

Management server 10 determines whether or not it has received the log data and the replay data from participant game device 30P who finished the game match (step S403). When management server 10 has not received the log data and the replay data (NO in step S403), it performs log data output processing (step S406). Specifically, management server 10 transmits the log data received from participant game device 30P to host terminal 20H1 and participant terminal 20P. At this time, management server 10 should only transmit information indicating the result of the game match to terminal 20, or may transmit the information with a part of the log data being processed.

Management server 10 determines whether or not it has received the report data from participant terminals 20P of all participants who played the game match (step S407). When management server 10 has not received the report data from all (NO in step S407), it repeats processing in step S407.

When management server 10 has received the report data from all of the participants who played the game match (YES in step S407), it determines whether or not a predetermined condition for the report data has been satisfied (step S408). As described above, the predetermined condition is a condition that the contents in the report data received from the plurality of participants match. When the predetermined condition has not been satisfied (NO in step S408), management server 10 requests all participants who played the game match to submit again the report data (step S409). At this time, management server 10 notifies host terminal 20H1 of presence of the game match for which it has requested re-submission of the report data.

Management server 10 determines whether or not it has received an instruction for decision by the host (step S410). The instruction for decision by the host refers to processing for forcibly determining the result of the game match with the host's rights when contents in the report data received from the plurality of participants do not match. The host transmits the decision instruction to management server 10 through host terminal 20H1. Specifically, when a state where there is discrepancy in recognition about victory and defeat of the game match between the participants continues and the result of the game match cannot be finalized, the right to determine the result of the game match is entrusted to the host in the first embodiment. Specifically, management server 10 can update the result of the game match with the host's rights regardless of whether or not the predetermined condition for the report data is satisfied.

When the predetermined condition has been satisfied (YES in step S408), management server 10 performs processing for finalizing the result of the game match in accordance with the contents in the report data (step S411). When management server 10 has received the instruction for decision by the host (YES in step S410), it performs processing for finalizing the result of the game match in accordance with the instruction for decision by the host (step S411).

Management server 10 discards the session after it performs the processing for finalizing the result of the game match (step S412). In the first embodiment, the session is held by management server 10 until the processing for finalizing the result of the game match is performed. Thus, the same session can be used when the game match does not normally end due to occurrence of a trouble or the like and the participant is caused to execute the game match again. Timing to discard the session is not limited to timing immediately after the processing for finalizing the result of the game match is performed. In one aspect, management server 10 may discard the session after lapse of a predetermined period since the processing for finalizing the result of the game match was performed.

In the first embodiment, cost for management of a plurality of sessions in management server 10 can be reduced by discard of the session at the timing of end of the processing for finalizing the result of the game match. Management server 10 performs processing in step S310 in FIG. 13 after it discards the session.

### <D4. Request for Calling Host>

In succession, a call request to call the host by the participant will be described. In the present embodiment, the participant in the game competition can transmit to host terminal 20H1 through participant terminal 20P, a host call request to request for support by the host. FIG. 17 illustrates below, processing by host terminal 20H1 when it receives the host call request. FIG. 17 is a flowchart showing a procedure in giving a notification of a call request, in host terminal 20H1.

Host terminal 20H1 receives the host call request from participant terminal 20P (step S550). The participant can transmit from participant terminal 20P, the host call request any time while the game competition is held. For example, the participant may do so when a trouble such as failure in reception of the log data by the participant terminal occurs. The host call request transmitted from participant terminal 20P is transmitted once via management server 10, from management server 10 to host terminal 20H1. In succession, host terminal 20H1 gives a notification that a call request has been from the participant (step S551). More specifically, host terminal 20H1 shows participant information on the participant who has made the call request to host terminal 20H1. User H1 who is the host can thus readily identify the participant who requests for support by the host.

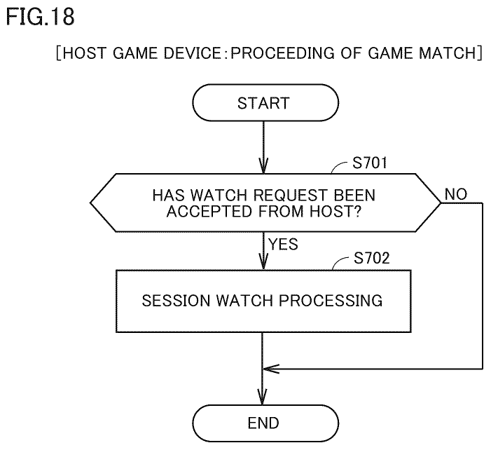

FIG. 18 is a flowchart showing a processing procedure relating to proceeding of the game match in host game device 30H1. The flowchart shown in FIG. 18 is performed by execution of system program 361 and game application execution program 360 by processor 34 of host game device 30H1.

In the first embodiment, the host can watch on host game device 30H1, the communication game being executed in participant game device 30P. Specifically, the host can watch in real time on host game device 30H1, a status of proceeding of the communication game, by participating in the session in which the participant has participated.

Host game device 30H1 determines whether or not it has accepted a watch request from the host (step S701). The watch request includes information for identification of the game match that the host desires to watch. When host game device 30H1 has not accepted the watch request from the host (NO in step S701), it quits the process. When host game device 30H1 has accepted the watch request from the host (YES in step S701), it performs session watch processing (step 702).

The session watch processing refers to processing for identifying the session corresponding to the game match included in the watch request based on information for identification of the game match and allowing the host to participate in the session. The host can thus watch in real time on host game device 30H1, the communication game played by the participants in the game match. At this time, communication unit 33 of host game device 30H1 communicates with participant game device 30P through P2P communication.

### <D5. After End of Game Match>

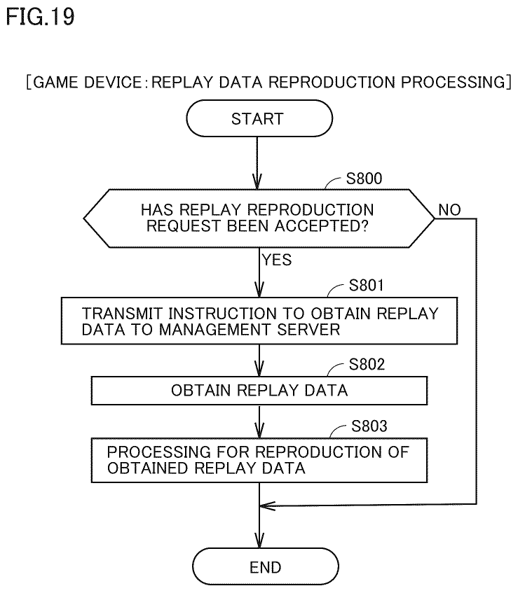

In succession, processing relating to end of the game match will be described with reference to FIGS. 19 to 21. FIG. 19 is a flowchart showing processing for reproducing replay data in game device 30 (participant game device 30P and host game device 30H1). The flowchart shown in FIG. 19 is performed by execution of system program 361 and game application execution program 360 by processor 34 of game device 30.

Game device 30 determines whether or not it has accepted a replay reproduction request (step S800). The replay reproduction request is an instruction from the host or the participant and an instruction for reproduction of replay of the communication game executed in the past. The replay reproduction request includes information that allows identification of the communication game played in the past. When game device 30 has not accepted the replay reproduction request (NO in step S800), it quits the process.

When game device 30 has accepted the replay reproduction request (YES in step S800), it transmits an instruction to obtain the replay data to management server 10 (step S801). The instruction to obtain the replay data is an instruction to request for downloading of the replay data of the communication game identified by the replay reproduction request from storage 16 of management server 10 to game device 30. Management server 10 transmits the replay data to game device 30 based on reception of the instruction to obtain the replay data. Game device 30 thus obtains the replay data (step S802). Game device 30 performs reproduction processing for reproducing the communication game executed in the past, based on the replay data (step S803).

The host and the participant can thus check contents in the communication game executed in the past. For example, when contents in the report data do not match and there is discrepancy in recognition between participants, the host can check what kind of communication game was actually executed. The host can check the contents in the communication game that ended and then determine the contents in the instruction for decision by the host.

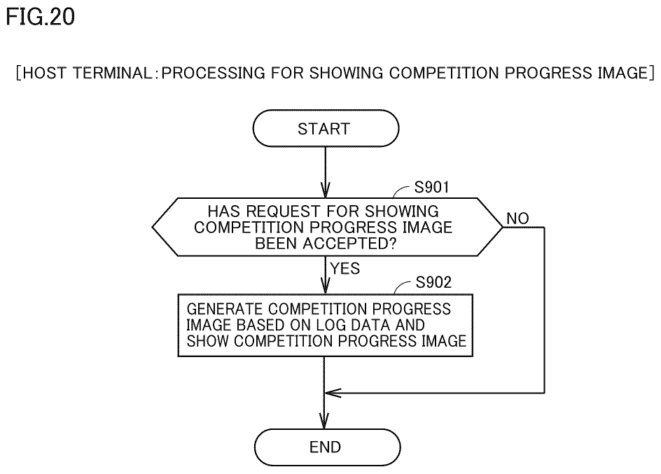

FIG. 20 is a flowchart showing processing for showing a competition progress image, in host terminal 20H1. The flowchart shown in FIG. 20 is performed by execution of system program 261 by processor 24 of host terminal 20H1.

Host terminal 20H1 determines whether or not it has accepted a request for showing a competition progress image from the host (step S901). The host makes the request for showing the competition progress image through operation portion 22 of host terminal 20H1. When host terminal 20H1 has not accepted the request for showing the competition progress image (NO in step S901), it quits the process. The competition progress image refers to an image generated based on the report data and an image showing progress of the game competition.

When host terminal 20H1 has accepted the request for showing the competition progress image (YES in step S901), it generates the competition progress image based on the report data stored in management server 10 and shows the competition progress image on display 21 (step S902). Specifically, host terminal 20H1 reads the report data stored in management server 10 and generates the competition progress image.

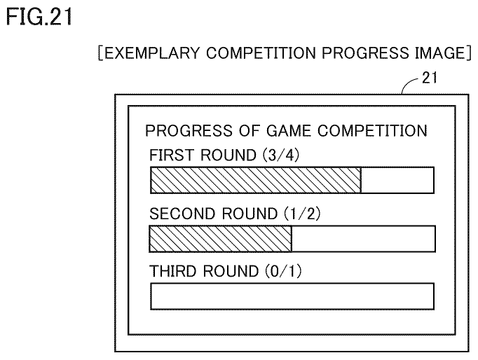

FIG. 21 is a diagram showing an exemplary competition progress image. FIG. 21 shows exemplary progress of the game competition in the elimination tournament in which eight participants participate. In an example where only the champion is determined in the elimination tournament in which the eight participants participate, a total of four game matches are executed in a first round, a total of two game matches are executed in a second round (a semi final), and one game match is executed in a third round (a final).

FIG. 21 shows with a gauge, the number of game matches that ended. The host can recognize that three game matches already ended in the first round including the four game matches, based on the competition progress image shown in FIG. 21. In addition, the host can recognize that three game matches ended in the second round (semi final) including the two game matches. As the number of game matches that ended is thus shown with the gauge, the host can visually recognize progress of the game competition. So long as the number of game matches that ended can visually be presented, an image using representation other than the gauge may be generated.

### E. Modification

Other forms which are partial modifications of the embodiment described above will be described below. The example described above illustrates that user H1 alone is the host. A plurality of hosts, however, may be present.

The example described above illustrates that, in connection with the session watch processing, the communication game can be watched on host game device 30H1. The communication game, however, may be watched on host terminal 20H1.

The example described above illustrates that, in connection with start of execution of the communication game, in step S505, participant game device 30P determines whether or not all of the participants corresponding to the session have participated and executes the communication game when all of them have participated. Participant game device 30P, however, may start execution of the communication game based on other conditions such as lapse of a predetermined period since the number of participants reached an already determined minimum number of participants, input onto participant game device 30P by the participant, a request from the host terminal, or a request from the host game terminal.

The example described above illustrates that the host (user H1) operates host terminal 20H1 and the participants (P1 to P4) in the game competition operate the participant terminals (20P1 to 20P4) and the participant game devices (30P1 to 30P4). The host (user H1), however, may be a person the same as at least one of the participants (P1 to P4). In this case, host terminal 20H1 may be the same as at least one of corresponding participant terminals (20P1 to 20P4). In other words, the host himself/herself may participate in the game competition as the participant.

The example described above illustrates that the communication game is the PVP type game. The communication game, however, may be a player vs environment (PvE) type game, without being limited to the PVP type game. For example, user P1 and user P2 may be invited to defeat an enemy controlled by a computer and user P1 and user P2 may be invited to compete against each other in contribution to defeat of the enemy.

The example described above illustrates that the elimination tournament or the league competition may be adopted as the form of proceeding of the game competition. The form of proceeding of the game competition, however, may be another form. For example, the form of proceeding of the game competition may be a double elimination tournament rather than a single elimination tournament. In other words, the form of proceeding of the game competition may be a form of proceeding in which a participant who was once suffered a defeat can play again.

In the example described above, there are four participants in the game competition who are users P1 to P4. The number of participants in the game competition, however, is not limited to four, and two, five, sixty-four, or one thousand participants may be applicable.

The example described above illustrates that management server 10, terminal 20, and game device 30 are each described as an integrated apparatus as shown in FIGS. 3 to 5. Each of management server 10, terminal 20, and game device 30, however, may be implemented as an assembly of a plurality of apparatuses. For example, game device 30 may be implemented by combination of a plurality of independent apparatuses. More specifically, a configuration composed of a main body portion including hardware corresponding to processor 34, memory 35, and storage 36 and a terminal portion including hardware corresponding to display 31 and operation portion 32 may be adopted.

The processor may be composed of a single chip or a plurality of chips. Furthermore, a processor and associated processing circuitry may be composed of a plurality of computers connected to one another through a wire or wirelessly over a local area network or a wireless network. The processor and the associated processing circuitry may be implemented by such a cloud computer as performing remote computation based on input data and outputting a result of computation to another device located at a distant location.

The example above illustrates that management server 10 randomly generates a bracket with the use of random numbers in the pairing information generation processing. Management server 10, however, may generate the bracket based on the participant information rather than randomly generation of the bracket. For example, management server 10 may cause users close to each other in skills in the communication game or in total time of play of the communication game to play against each other. Zest of the game match can thus be improved.

The example above illustrates that, in the session generation processing, management server 10 performs the session generation processing based on the fact that the set time and date to hold the game competition has come. Management server 10, however, may perform the session generation processing in advance before the time and date to hold the game competition comes. Thus, when the session cannot be generated due to some kind of trouble, a period during which the host deals with the trouble can be provided.

The example above illustrates that the log data includes information for identification of a user who is a winner and a user who is a loser, as the result of the game match. The log data, however, may include more specific information on the game match. In an example where such game rules that users shoot down each other are laid down, the log data may include the number of times of shooting down and the number of times of being shot down for each user. In an example where the league competition has been set as the rules of the game competition and ranks among the users cannot be determined only based on the results of the game match, the ranks among the users can be determined based on an indicator such as the number of times of shooting down included in the log data. Alternatively, in an example where such rules that a duration of the game match is varied by actions taken by the participants are laid down, the log data may include the duration of the game match.

The example above illustrates that the replay data includes a command inputted by the participant while the communication game is being executed. The replay data, however, may be, for example, moving image data itself for checking contents in the communication game that ended. In that case, the replay data can be checked on the terminal, without being limited to the game device.

The example above illustrates that, in connection with the log data output processing, management server 10 transmits the log data to both of host terminal 20H1 and participant terminal 20P. The management server, however, may transmit the log data only to one of host terminal 20H1 and participant terminal 20P. For example, management server 10 may output the log data only to host terminal 20H1. The participant can recognize the result of the game match on participant game device 30P.

The example described above illustrates that the predetermined condition for the report data is such a condition as determination as to whether or not contents in a plurality of pieces of report data received by the management server match. The predetermined condition, however, may be a condition that the contents in the log data match with the contents in the report data.

Since the game competition hosted in the first embodiment is a competition hosted by user H1 who is the player of the communication game, unique rules determined among the users, that cannot be set on the communication game, may be adopted. In this case, the winner indicated by the log data of the communication game may be different from the winner based on reflection of the unique rules. By checking match of the contents in the log data with the contents in the report data, proceeding of the game competition while there is discrepancy between the result of the game match recognized by the user and the log data can be suppressed.

The example above illustrates that the report data is transmitted from participant terminal 20P to management server 10. The report data, however, may be transmitted from participant game device 30P to management server 10. In other words, the participant may input the report data to participant game device 30P.

The example described above illustrates that, in connection with the pairing information generation processing, management server 10 determines pairing in the game match to be played by each participant at the timing of reception of the participation requests as many as the defined number of participants. Management server 10, however, may determine the pairing in the game match each time it receives each participation request. For example, management server 10 determines the pairing of the participants in the order of reception of the participation request. More specifically, management server 10 may determine a bracket, for example, in such a manner that the participant who transmits the participation request firstly plays against the participant who transmits the participation request secondly and the participant who transmits the participation request thirdly plays against the participant who transmits the participation request fourthly.

Though the example described above illustrates that, in connection with notification of generation of the session or the like, participant game device 30P and participant terminal 20P give the notification through the display, they may output voice and sound from a speaker.

The example described above illustrates that the host sets the defined number of participants which is the maximum number of persons who can participate in the game competition. The host may set the minimum number of participants for holding the game competition in addition to the defined number of participants. Only the minimum number of participants for holding the game competition may be set, without setting the defined number of participants.

The example described above illustrates that, in connection with communication between participant game devices 30P in execution of the communication game, communication unit 33 communicates with another participant game device 30P through peer to peer (P2P) communication. While the communication game is executed, however, participant game devices 30P may communicate through a server.

The example above illustrates that, in connection with the guidance image that suggests an action to be taken by the participant, creation of the report data is suggested. In one aspect, however, the guidance image may show another action. For example, the guidance image may be an image indicating restoration of the Internet connection when the Internet connection is lost. Alternatively, the guidance image may be an image for notification of time of start of a next game match. The guidance image thus shows an action to be taken by the participant in accordance with a status of proceeding of the game competition and allows a game to smoothly proceed. In addition, though the example above illustrates that the guidance image is shown on participant terminal 20P, the guidance image may be shown on participant game device 30P.

The example described above illustrates that game device 30 reproduces the communication game that ended. In one aspect, however, terminal 20 may reproduce the communication game. The host can thus check the contents in the communication game in the past on host terminal 20H1 and the participant can check the contents in the communication game in the past on participant terminal 20P.

### Second Embodiment

In the first embodiment, the example in which the defined number of participants is four and four users P1 to P4 participate as the participants is described. In a second embodiment, an example in which participants participate in the game competition in a unit of a team. Description of features in the second embodiment identical to those in the first embodiment will not be repeated.

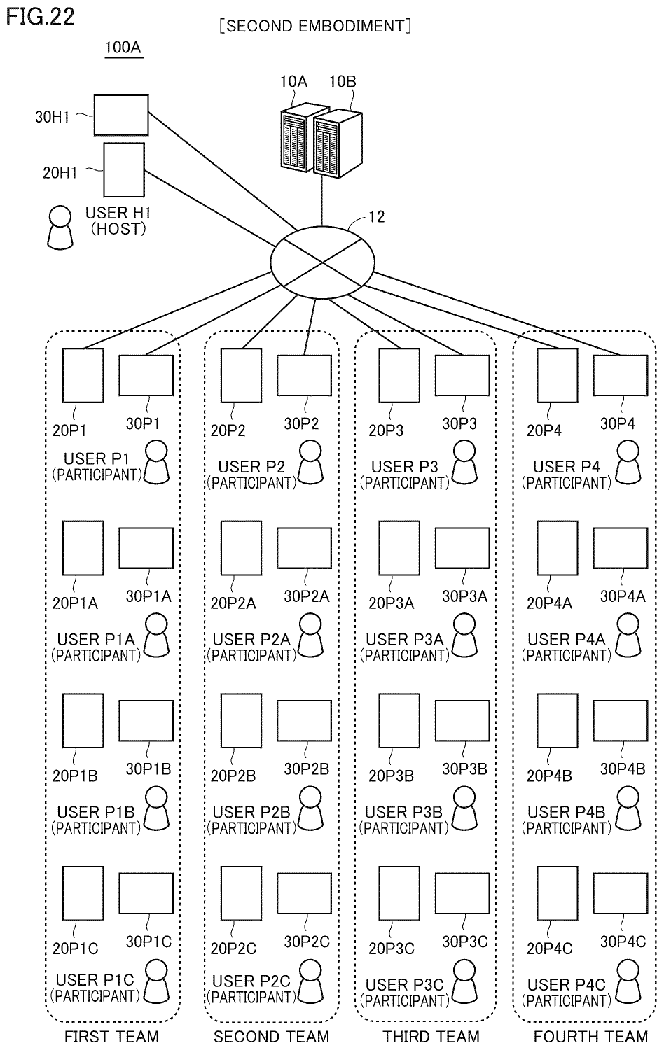

FIG. 22 is a schematic diagram showing an exemplary information processing system 100A according to the second embodiment. As shown in FIG. 22, in information processing system 100A in the second embodiment, four teams of first to fourth teams participate in the game competition as participants. In the game competition in the second embodiment, the host sets participation by a team consisting of four users as a participation condition.

Each of the first to fourth teams is composed of four users who play the communication game. In the second embodiment, the teams play against each other. For example, the first team and the second team play against each other and the third team and the fourth team play against each other.

In the example in FIG. 22, the first team includes user P1, a user PIA, a user P1B, and a user PIC. The second team includes user P2, a user P2A, a user P2B, and a user P2C. The third team includes user P3, a user P3A, a user P3B, and a user P3C. The fourth team includes user P4, a user P4A, a user P4B, and a user P4C.

Participant terminals 20P1A, 20P1B, and 20P1C are terminals operated by respective users P1A, P1B, and P1C. Participant terminals 20P2A, 20P2B, and 20P2C are terminals operated by respective users P2A, P2B, and P2C. Participant terminals 20P3A, 20P3B, and 20P3C are terminals operated by respective users P3A, P3B, and P3C. Participant terminals 20P4A, 20P4B, and 20P4C are terminals operated by respective users P4A, P4B, and P4C.

Participant game devices 30P1A, 30P1B, and 30P1C are terminals operated by respective users P1A, P1B, and P1C. Participant game devices 30P2A, 30P2B, and 30P2C are terminals operated by respective users P2A, P2B, and P2C. Participant game devices 30P3A, 30P3B, and 30P3C are terminals operated by respective users P3A, P3B, and P3C.

Participant game devices 30P4A, 30P4B, and 30P4C are terminals operated by respective users P4A, P4B, and P4C. Participant terminals 20P and participant game devices 30P operated by users P1A, P1B, and P1C to P4A, P4B, and P4C are connected to network 12.

Users P1 to P4 are respective representatives of the first to fourth teams. In the second embodiment, the representative transmits the participation request. The participation request in the second embodiment includes the participant information on members other than the representative included in the team. In one aspect, the representative may transmit the participant information on the member to management server 10 after it makes a provisional participation request. After the representative makes the provisional participation request, each of participating members himself/herself may transmit the participant information to management server 10. In the second embodiment, the representative may submit the report data.

In the second embodiment, even when the host has set participation of the team consisting of four persons as the participation condition, information processing system 100 in the present disclosure can be applied. As in the first embodiment, also in the second embodiment, in information processing system 100A that provides the communication game that can be played by a plurality of users, loads imposed by tasks at the time when user H1 (host) who is not a game operator hosts the game competition can be lessened. In the second embodiment, two or more teams may be present in one match such that the first team, the second team, and the third team play against one another.

In the second embodiment, management servers 10A and 10B are provided instead of management server 10 in the first embodiment. Management server 10A in the second embodiment is a server for management of the replay data and the log data and update of pairing information. Management server 10B is a general-purpose server that performs processing for generating the session. Management server 10B is a server that generates a session in which a plurality of users can participate, rather than a server specialized in the communication game in the present embodiment.

In other words, the session generated by management server 10B is applicable also to a communication game other than the specific communication game in the present embodiment. As shown in the second embodiment, information processing system 100A may include a plurality of management servers 10A and 10B. Management servers 10A and 10B may correspond to the “competition management system” in the present disclosure.

### Third Embodiment

In the first embodiment, the example in which management server 10 finalizes the result of the game with the report data is described. In a third embodiment, an example in which management server 10 finalizes the result of the game without using the report data will be described. Description of features in the third embodiment identical to those in the first embodiment will not be repeated.

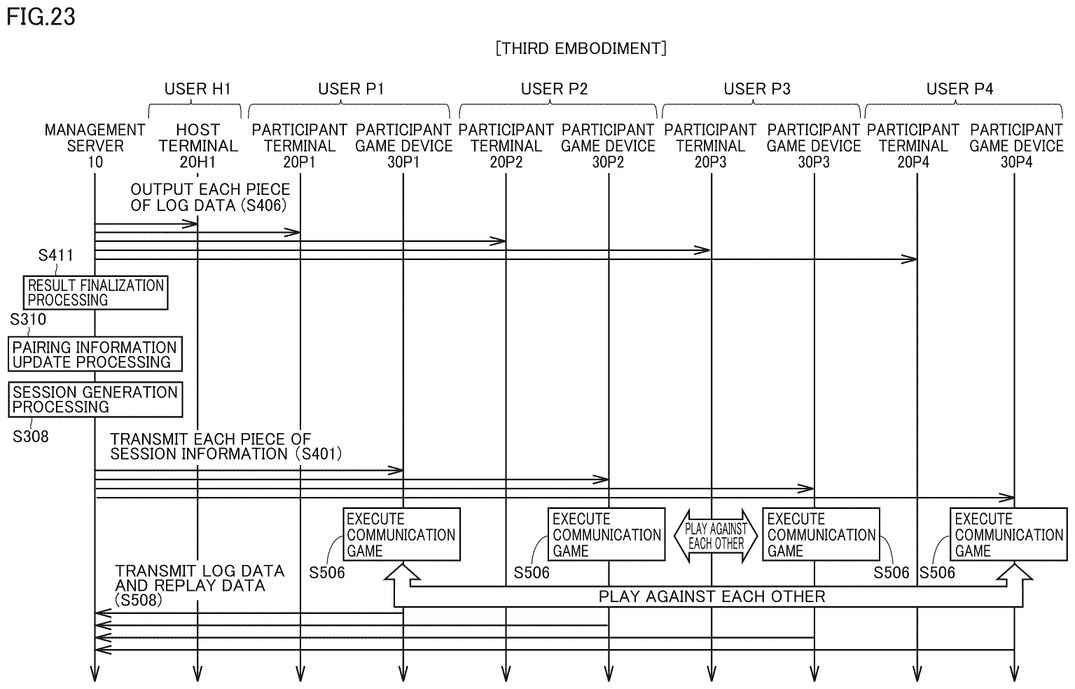

FIG. 23 is a second sequence diagram showing proceeding of the game competition in the third embodiment. Referring to FIG. 23, in the third embodiment, after management server 10 outputs the log data, participant terminal 20P does not transmit the report data. In other words, in the third embodiment, the participant is not obliged to submit the report data.

In the third embodiment, management server 10 finalizes the result of the game match based on the log data. In other words, in the third embodiment, the game competition proceeds, with the result of the game match determined by game device 30 being defined as the reference. Thus, in the third embodiment, a procedure required for proceeding of the game competition and performed by the participant can be simplified so that the game competition can smoothly proceed. When the participant does not agree with the result of the game match, the participant can make the host call request to request for update of the result of the game match with the host's rights also in the third embodiment.

### I. Advantages

Thus, in information processing systems 100 and 100A according to the present embodiment, management server 10 automatically generates and transmits the session and generates and updates pairing information with proceeding of the game competition. Loads imposed by tasks on user H1 (host) who hosts the game competition can thus be lessened.

More specifically, in the present embodiment, user H1 (host) does not have to do such complicated tasks as notification about the form of proceeding of the game competition and rules of the game match, determination and notification about pairing (bracket) of participants who play the game, and adjustment of time and day. In the present embodiment, loads imposed by tasks performed by the participant in addition to user H1 (host) can be lessened. For example, in the present embodiment, the participant himself/herself does not have to set the rules of the game match.

Furthermore, since the participant can play the game match against a predetermined opponent by participating in the session generated by management server 10, the participant does not have to establish friend relation with the opponent. The friend relation refers to relation that users can check statuses between/among them or can interact between/among them on the communication game. Information indicating the friend relation between/among the users who play the communication game is stored in the server on which the communication game runs. In the present embodiment, the participant can participate in the game competition without performing a procedure for increasing users with which friend relation is unnecessarily established.

While certain example systems, methods, devices, and apparatuses have been described herein, it is to be understood that the appended claims are not to be limited to the systems, methods, devices, and apparatuses disclosed, but on the contrary, are intended to cover various modifications and equivalent arrangements included within the spirit and scope of the appended claims.

What is claimed is:

1. An information processing system that assists proceeding of a game competition where a communication game is utilized, the information processing system comprising:
a competition management system configured with at least one information processing apparatus, the competition management system managing the game competition;
a host terminal operated by a host, the host terminal configured to communicate with the competition management system;
a participant terminal operated by a participant in the game competition, the participant terminal configured to communicate with the competition management system; and
a participant game device operated by the participant in the game competition, the competition management system comprises
one or more first processors, and
one or more first memories storing instructions that, when executed, cause the one or more first processors to perform operations comprising wherein
generating information for holding the game competition based on competition setting information inputted to the host terminal,
in response to a participation request for participation in the game competition accepted from the participant terminal, registering participant information of a participant who has made the participation request and the game competition in association with each other,
generating from a plurality of registered participation requests, pairing information indicating pairing of participants who play the communication game together,
generating a session for play of the communication game together by participants in pairing designated by the pairing information among participants who have made the participation request for participation in the game competition, in association with the participants in the designated pairing, and
transmitting session information corresponding to the generated session to the participant game device of the participant associated with the session,
the participant game device comprises
one or more second processors, and
one or more second memories storing instructions that, when executed, cause the one or more second processors to perform operations comprising
communicating with the participant game device of at least one other participant who participates in a session corresponding to the session information,
executing the communication game together with the at least one other participant who participates in the session, and
transmitting log data of the communication game to the competition management system,
the operations performed by the one or more first processors comprise
outputting the log data to at least one of the host terminal and the participant terminal,
storing report data inputted to the participant terminal, the report data indicating a result of the communication game played by the participant, and
upon a predetermined condition for the report data being satisfied, updating the pairing information based on the report data, with the result of the communication game being regarded as being finalized, and
the generating a session in association with the participants in the designated pairing comprises generating a session for play of the communication game together by the participants in the pairing designated by the updated pairing information, in association with the participants in the designated pairing.

2. The information processing system according to claim 1, wherein
the one or more first processors, responsive to executing the instructions, further perform transmitting generation information indicating generation of the session to the participant terminal corresponding to the session.

3. The information processing system according to claim 1, wherein
the one or more second processors, responsive to executing the instructions, further perform outputting session information on the session corresponding to the obtained session information, and
the communicating with the participant game device of another participant comprises communicating, based on an input to the session information of the participant, with another game device that participates in the session corresponding to the session information.

4. The information processing system according to claim 1, wherein
the executing the communication game played together with the another participant comprises executing the communication game, match-up condition setting of which is set in advance based on the competition setting information.

5. The information processing system according to claim 1, further comprising a host game device, wherein
the host game device comprises
one or more third processors, and
one or more third memories storing instructions that, when executed by the one or more third processors, cause the one or more third processors to perform communicating with the participant game device who participates in a session designated by the host.

6. The information processing system according to claim 1, wherein
the one or more second processors, responsive to executing the instructions, further perform transmitting to the competition management system, replay data for reproduction of the communication game executed by execution of the communication game to be played together with the at least one other participant,
the one or more first processors, responsive to executing the instructions, further perform storing the replay data, and
the one or more second processors, responsive to executing the instructions, further perform operations comprising
obtaining the replay data from the competition management system, and
reproducing the communication game based on the replay data.

7. The information processing system according to claim 1, wherein
the storing report data indicating a result of the communication game played by the participant comprises storing the report data obtained from a plurality of participants who participated in the session, and
the updating the pairing information based on the report data comprises determining, when contents indicated by the report data obtained at least from a first participant match with contents indicated by the report data obtained from a second participant among the participants who participated in the session, the predetermined condition as having been satisfied and updating the pairing information.

8. The information processing system according to claim 1, wherein
the one or more first processors, responsive to executing the instructions, further perform giving a notification to the host terminal based on an operation onto the participant terminal.

9. The information processing system according to claim 1, wherein
the one or more first processors, responsive to executing the instructions, further perform editing the pairing information based on an operation onto the host terminal.

10. The information processing system according to claim 1, wherein
the updating the pairing information based on the report data comprises updating a result of the communication game based on an operation onto the host terminal regardless of whether the predetermined condition has been satisfied.

11. The information processing system according to claim 1, wherein
the one or more first processors, responsive to executing the instructions, further perform discarding the session for playing the communication game after the result of the communication game is finalized.

12. The information processing system according to claim 1, wherein
the communicating with the participant game device of another participant comprises establishing peer to peer (P2P) communication with another participant game device that participates in the session.

13. The information processing system according to claim 1, wherein
the participant terminal comprises
one or more fourth processors, and
one or more fourth memories storing instructions that, when executed by the one or more fourth processors, cause
the one or more fourth processors to perform
showing a guidance image showing an action to be taken by the participant in accordance with a status of progress of the game competition, or
the one or more second processors, responsive to executing the instructions, to perform
showing a guidance image showing an action to be taken by the participant in accordance with a status of progress of the game competition.

14. The information processing system according to claim 1, wherein
the host terminal comprises
one or more fifth processors, and
one or more fifth memories storing instructions that, when executed by the one or more fifth processors, cause the one or more fifth processors to perform showing a competition progress image showing progress of the game competition based at least on the report data obtained at least from the competition management system.

15. The information processing system according to claim 1, wherein
the competition setting information comprises a participation condition for participation in the game competition, and
the registering participant information of a participant and the game competition in association with each other comprises determining whether to make registration based on the participation condition.

16. The information processing system according to claim 1, wherein
the competition setting information comprises a defined number of participants, and
the updating the pairing information based on the report data comprises generating the pairing information when the participation request(s) as many as the defined number of participants is/are received.

17. A non-transitory computer-readable storage medium with an executable information processing program stored thereon, the information processing program being executed by one or more processors included in an information processing system that assists proceeding of a game competition in which a communication game is utilized, the information processing system comprising
a competition management system configured with at least one information processing apparatus, the competition management system managing the game competition,
a host terminal operated by a host, the host terminal configured to communicate with the competition management system,
a participant terminal operated by a participant in the game competition, the participant terminal configured to communicate with the competition management system, and
a participant game device operated by the participant in the game competition,
the information processing program causing the one or more processors to perform operations comprising:
generating information for holding the game competition based on competition setting information inputted to the host terminal;
in response to a participation request for participation in the game competition accepted from the participant terminal, registering participant information of a participant who has made the participation request and the game competition in association with each other;
generating from a plurality of registered participation requests, pairing information indicating pairing of participants who play the communication game together;
generating a session for play of the communication game together by participants in pairing designated by the pairing information among participants who have made the participation request for participation in the game competition, in association with the participants in the designated pairing;
transmitting session information corresponding to the generated session to the participant game device of the participant associated with the session;
outputting log data indicating a result of the communication game received from the participant game device to at least one of the host terminal and the participant terminal;
storing report data inputted to the participant terminal, the report data indicating a result of the communication game played by the participant;
upon a predetermined condition for the report data being satisfied, updating the pairing information based on the report data, with the result of the communication game being regarded as being finalized; and
generating a session for play of the communication game together by the participants in the pairing designated by the updated pairing information, in association with the participants in the designated pairing.

18. An information processing method to be performed by one or more processors included in an information processing system that assists proceeding of a game competition in which a communication game is utilized, the information processing system comprising
a competition management system configured with at least one information processing apparatus, the competition management system managing the game competition,
a host terminal operated by a host, the host terminal configured to communicate with the competition management system,
a participant terminal operated by a participant in the game competition, the participant terminal configured to communicate with the competition management system, and
a participant game device operated by the participant in the game competition, the information processing method comprising:
generating information for holding the game competition based on competition setting information inputted to the host terminal;
in response to a participation request for participation in the game competition accepted from the participant terminal, registering participant information of a participant who has made the participation request and the game competition in association with each other;
generating from a plurality of registered participation requests, pairing information indicating pairing of participants who play the communication game together;
generating a session for play of the communication game together by participants in pairing designated by the pairing information among participants who have made the participation request for participation in the game competition, in association with the participants in the designated pairing;
transmitting session information corresponding to the generated session to the participant game device of the participant associated with the session;
outputting log data indicating a result of the communication game received from the participant game device to at least one of the host terminal and the participant terminal;
storing report data inputted to the participant terminal, the report data indicating a result of the communication game played by the participant;
upon a predetermined condition for the report data being satisfied, updating the pairing information based on the report data, with the result of the communication game being regarded as being finalized; and
generating a session for play of the communication game together by the participants in the pairing designated by the updated pairing information, in association with the participants in the designated pairing.

19. An information processing system that assists proceeding of a game competition where a communication game is utilized, the information processing system comprising:
a competition management system configured with at least one information processing apparatus, the competition management system managing the game competition;
a host terminal operated by a host, the host terminal configured to communicate with the competition management system;
a participant terminal operated by a participant in the game competition, the participant terminal configured to communicate with the competition management system; and
a participant game device operated by the participant in the game competition, wherein
the competition management system comprises
one or more first processors, and
one or more first memories storing instructions that, when executed, cause the one or more first processors to perform operations comprising
generating information for holding the game competition based on competition setting information inputted to the host terminal,
in response to a participation request for participation in the game competition accepted from the participant terminal, registering participant information of a participant who has made the participation request and the game competition in association with each other,
generating from a plurality of registered participation requests, pairing information indicating pairing of participants who play the communication game together,
generating a session for play of the communication game together by participants in pairing designated by the pairing information among participants who have made the participation request for participation in the game competition, in association with the participants in the designated pairing, and
transmitting session information corresponding to the generated session to the participant game device of the participant associated with the session,
the participant game device comprises
one or more second processors, and
one or more second memories storing instructions that, when executed, cause the one or more second processors to perform operations comprising
communicating with the participant game device of at least one other participant who participates in a session corresponding to the session information,
executing the communication game played together with the at least one other participant who participates in the session, and
transmitting log data of the communication game to the competition management system,
the one or more first processors, responsive to executing the instructions, further perform operations including
outputting the log data to at least one of the host terminal and the participant terminal, and
finalizing a result of the communication game based on the log data and updating the pairing information based on the finalized result of the communication game, and
the generating a session in association with the participants in the designated pairing comprises generating a session for play of the communication game together by the participants in the pairing designated by the updated pairing information, in association with the participants in the designated pairing.
